(19) United States
(12) Patent Application Publication
(10) Pub. No.: US 2004/0167787 A1
(43) Pub. Date: Aug. 26, 2004

(54) Systems and methods for network-based design submission and management

(75) Inventors: Morgan Lynch, Cedar Hills, UT (US); George Willis Dempster IV, Orem, UT (US)

Correspondence Address: WORKMAN NYDEGGER (F/K/A WORKMAN NYDEGGER & SEELEY), 60 EAST SOUTH TEMPLE, 1000 EAGLE GATE TOWER, SALT LAKE CITY, UT, 84111, US

(73) Assignee: Arteis, Inc

(21) Appl. No.: 10/371,895

(22) Filed: Feb. 21, 2003

(51) Int. Cl. G06F 17/60

(52) U.S. Cl. 705/1

(57) ABSTRACT

A system, method, and software are provided that facilitate management of work projects in a computer network operating environment that includes a management platform accessible by way of a client portal and a contractor portal. Client initiated project requests are transmitted from the client portal to the management platform and made available, through the management platform, to a preselected group of contractors by way of the contractor portal. One or more contractors then commit to performing work on the work project. The management platform sets a timetable and other parameters relating to execution of the project and sends an email to the client informing the client of contractor acceptance of the project, and also sends an email to the contractor that contains the timetable. Upon completion of the project by the contractors, the end product is transmitted to the management platform for relay to the client for review and acceptance.

### BACKGROUND OF THE INVENTION

### CROSS-REFERENCE TO RELATED APPLICATIONS

Not applicable.

1. Field of the Invention

The present invention relates generally to initiation, management and execution of work projects in a computer network environment. More particularly, embodiments of the present invention relate to systems, methods, and software for use in defining, implementing and managing relationships between clients and a preselected group of contractors so as to facilitate economically efficient relationships directed to the execution, by the contractors, of work projects identified and requested by the clients.

2. Related Technology

A recurring problem in many industries is a lack of vehicles or systems to bring widely dispersed production resources to bear on the unmet demands of multiple clients. In c the design field for example, there is a relatively steady demand for high quality design work. Correspondingly, there is a demand in the designer community for a stable work load of satisfying and profitable work projects. However, though there is often a suitable supply of designer services, as well as adequate demand for those services, clients and designers have largely been unable to match their respective demands and services in an economically satisfactory and efficient manner. For example, while a client can obtain design services from a single supplier, it is typically difficult to obtain services from multiple suppliers—both from a logistical and a cost standpoint.

One approach to this type of problem is to take advantage of the communication capabilities of a computer network environment, such as the Internet. Because such environments generally eliminate the need for personal, physical interaction between clients and designers, they can enable the formation of relationships between clients and designers that could not exist in other circumstances. However, significant problems remain with regard to this work management and execution model. For example, problems can occur due to the lack of effective mechanisms to match designers and clients in an economically efficient way. Moreover, use of a computer network as the sole communication medium—especially in the area of design services—limits the ability to monitor and ensure that quality design services are being provided to a given client. Also, problems can arise in the context of how services are paid for by a client, and how suppliers are paid for their services.

With consideration first of the client perspective, a variety of problems are implicated by the processes relating to the solicitation, execution and management of work projects identified by the client. The solicitation process, for example, is concerned with the identification of a project desired to be executed on behalf of the client, and solicitation of bids to perform the identified work. Generally, solicitation of bids to perform work identified by the client may be implemented in a variety of ways. In some cases, a client prepares a creative brief that essentially outlines the nature and scope of the project to be performed. The client then posts the creative brief on a bulletin board or other location where it is accessible to any interested designer with access to the bulletin board.

One concern with such a solicitation process is that the client has no assurance that a satisfactory type or number of bids will be received for any given project identified by the client. For example, a client may, in some instances, receive a wide variety of bids for one identified project while, in other cases, the client may receive a few or no bids for the identified project. At least in those cases where few or no bids are received, the client may effectively be forced to accept a less than satisfactory design in order to meet deadlines or other obligations.

On the other hand, if the client receives numerous bids for a particular project, the client is then compelled to spend time reviewing and comparing the bids in an effort to determine which bid is most desirable in terms of aspects such as costs, value, timeliness, and quality. Due to differences in the way in which prospective contractors may prepare their bids, such comparison by the client will be both labor intensive and may ultimately prove fruitless if the client is not able to make adequate comparisons between bids such as would be necessary to support a decision concerning which bid to accept. Moreover, many clients may lack the time and/or skills necessary to perform a thorough and objective evaluation of the various bids received.

The bid solicitation process performed by the client implicates various other problems as well. For example, clients generally have no way to determine whether or not any particular contractor or designer bidding on the work project identified by that client has achieved any particular level of competency. The inability of the client to screen out designers of limited skill can, among other things, result in the client accepting a bid from such a designer and ultimately receiving a product that is unsatisfactory. A client's only recourse in this situation may be to merely accept a bid from yet another designer and hope that the resulting product is satisfactory. Obviously, this approach could move to be very expensive and inefficient.

Yet other concerns from the client perspective relate to the execution of the work after a bid has been solicited and accepted by the client. As an example, once the bid has been accepted, the client typically has little or not control over the timeliness with which the work will be completed. This is particularly so in cases where the client has solicited work by way of an Internet bulletin board or similar mechanism. In cases such as these, the client and the contract designer may be physically located in different states or in different parts of the country. Thus, it may be difficult for the client to bring sufficient pressure to bear on the designer to ensure that the work is produced on time. In similar fashion, it may be difficult for the client to ensure that the end product received is of sufficient quality.

Moreover, it is often difficult for the client to ensure that optimal value is received for the amount paid. By way of example, it is generally the case that relatively more experienced designers charge higher rates than relatively less experienced designers. In the event that a client contracts with a relatively more experienced designer for the preparation of a product that could be satisfactorily completed by a less experienced designer, the client may nonetheless be compelled to pay the higher rate typically charged by the more experienced designer. While the client may receive a relatively high quality end product, the same quality product may have been available in a lower cost from another designer.

A further concern relating to work execution is that typical work management models, particularly those implemented in a computer network type of operating environment, are inherently inflexible and, therefore, unable to quickly or readily adapt to changing client needs. For example, because clients are typically compelled to solicit bids from an undefined group of contractors or designers who are not affiliated with each other in any way, the client may not be able to effectively bring the aggregate capabilities of such contractors to bear on particular projects. Thus, in a situation where a client requires performance of a large project, it would be difficult, if not impossible, for the client to coordinate the efforts of multiple independent contractors so as to facilitate timely and efficient execution of a high quality work product. This is due at least in part to the fact that because the designers are independent, there is no mechanism or system in place to coordinate their respective efforts with regard to the project defined by the client.

As suggested by the foregoing, as well as by the discussion elsewhere herein concerning various issues apparent from the perspective of the designer, at least some of the problems that arise as a result of the interaction between clients and contractors stem from the fact that there is little or no management of the relationship between the client and the designer.

For example, in cases such as those where a bulletin board or similar system or mechanism is used to facilitate interaction between clients and designers, the bulletin board operator typically does nothing more than facilitate the initial interaction. It plays virtually no role in the solicitation, execution or management of any subsequent work project(s). Such a lack of coordination and management also materially impairs the flexibility of the overall system in responding to client needs. Moreover, the inherently passive nature of systems such as these means that the negotiation and resolution of any disputes or other problems that may arise are left to the client and the contractor.

Another concern is that the relationship between the client and the contractor is inherently limited in terms of the functionality that it affords the client. One example is where the client wants to use certain art work that has been developed by a designer as a corporate logo that can incorporated into stationery, letterhead paper and various other client materials. In a case such as this, even if the client has been able to enter into a successful relationship with the designer, the client nonetheless bears the burden of putting the finished design product into the form in which it will ultimately be employed. In this case, the designer, after having received the finished art work, must then contract with stationers or other companies to incorporate the art work into various materials desired by the client.

As suggested earlier, existing methods and systems that are intended to establish relationships and facilitate interactions between clients and contractors are problematic not only from the client perspective, but from the contractor or designer perspective as well. At least some of such problems stem from a lack of active management of the relationship between contractors and clients or prospective clients.

For example, contractors that avail themselves of such systems and methods may find that they obtain somewhat less than their desired volume of work. In at least some cases, this is due to the fact that any given contractor may be competing with a relatively large number of other contractors for one or more jobs identified by one or more clients. Thus, the designer may experience a workload that is quite high at some times, while being quite low at other times. This problem is of particular concern to freelance contractors who often would prefer to have a relatively steady workload rather than a cyclical workload.

Yet other concerns can relate to the compensation mechanisms for contractors. For example, in the case where a dispute arises concerning the payment to be made by a client, the contractor may have little or no leverage in obtaining full or even partial payment in the event that the client decides not to pay.

Moreover, if a prospective designer is required to submit various proposed designs or concepts as part of a bid process, the designer generally would be unable to recoup any costs and expenses incurred in developing those designs if the designer is not ultimately awarded the work contract by the client. Thus, a designer or other contractor runs a risk that the significant time, expense and effort expended in developing concept proposals will likely not be recovered if the proposed bid is not accepted.

Further concerns relate to the ability of the designer to obtain work in environments such as those described above. As noted earlier, a designer or other contractor may be in competition with a relatively large number of other contractors to obtain work identified by a client. Thus, it may be difficult for the contractor to distinguish his or her work in the mind of a prospective client or clients, because such clients may be exposed to a relatively large array of designers and work quality levels.

A related concern that arises with respect to with respect to existing approaches is that it may be difficult for a designer to readily and objectively evaluate his or her progress and improvement as a designer. This is due in part to the fact that the feedback received by the designer is typically limited to feedback provided by the client that may or may not be objective and helpful. As the independent designer typically has little or no interaction with peers, the designer may not have access to objective input. Such a lack of objective feedback may hinder the growth and development of the skills of the designer.

Various other concerns are likewise implicated with respect to the performance of the contractor. For example, the formation of relationships between clients and designers typically are not structured to provide incentives for contractors such as designers to improve their performance. This problem may result from a variety of factors including a lack of awareness on the part of the client as to the skill and ability of the contractor. In this case, poor quality work performed by a contractor may not be perceived or appreciated by the client, so that the contractor can continue to generate low quality work without fear of a corresponding loss in workload. This is particularly true where there is a large pool of prospective clients, since a poorly performing contractor can readily make up for the loss of a client by performing work for other, similarly unaware clients.

Contractors may also lack incentives to perform in other situations as well. For example, if a contractor is aware that a client has an urgent need for particular services or products, that client may take advantage of the situation by producing low-cost, sub-par work that the client is effectively forced to accept, given the urgent nature of the project.

In view of the foregoing problems, and other problems in the art not specifically enumerated herein, what is needed are systems, methods, and software that facilitate active management of interactions and relationships between prospective clients and prospective contractors. Such systems, method and software should also foster economically efficient relationships that provide the client with high quality work at a reasonable price, and that provide a relatively steady and satisfying workload to the contractor.

### SUMMARY OF EXEMPLARY EMBODIMENTS OF THE INVENTION

In general, embodiments of the invention are directed to systems, methods, and software for use in defining, implementing and managing economically efficient interactions and relationships between clients and a preselected group of contractors so as to facilitate execution, by the contractors, of work projects identified and requested by the clients.

One exemplary embodiment of the invention is implemented in a computer network that includes a management platform accessible by way of a client portal and a contractor portal. In this exemplary implementation, a client desiring a design product, such as a corporate or business logo for example, enters the client portal and defines a project request that contains information concerning the desires of the client with respect to the logo. The completed project request is then transmitted to the management platform from the client portal. After receipt of the project request, the management platform then makes the project request available to a preselected group of contractors, in accordance with various criteria. One or more of the contractors, viewing the project request by way of the contractor portal, can then decide whether or not to commit to perform the project. In the event that the contractor wishes to perform the project, the contractor then transmits a project commitment to the management platform from the contractor portal. After such acceptance, the contractor may be asked to perform a peer review of work developed by other contractors associated with the system.

The management platform then sets a timetable and other parameters relating to execution of the project. For example, depending on the implementation desired, the management platform could send an email notification to the client informing the client of the contractor acceptance of the project, and/or could send an email to the contractor that contains the timetable. The contractor then completes the project and uploads graphics, or other files, to the management platform where the files are reviewed and a read-only version is then made available to the client by way of the client portal. When the client has accepted and paid for the product, the management platform then provides the complete file to the client. Depending on the arrangement, the client will have already paid for the product at this point in time; however, payment schedules can vary depending on agreement by the parties involved.

In this way, the relationship between the contractor and the client is actively managed through the management platform so that economically efficient interactions and relationships between clients and a preselected group of contractors can be readily defined and implemented. The foregoing, and other, aspects of embodiments of the present invention will become more fully apparent from the following description and appended claims.

### BRIEF DESCRIPTION OF THE DRAWINGS

In order that the manner in which the above-recited and other advantages and features of the invention are obtained, a more particular description of the invention briefly described above will be rendered by reference to specific embodiments thereof which are illustrated in the appended drawings. Understanding that these drawings depict only typical embodiments of the invention and are not therefore to be considered limiting of its scope, the invention will be described and explained with additional specificity and detail through the use of the accompanying drawings in which:

FIG. 1 is a schematic view illustrating various aspects of exemplary relationships between a client, contractor and management entity, such as may be defined in connection with the invention;

FIG. 2 is a schematic view providing further details concerning the exemplary relationships illustrated in FIG. 1, with particular attention to various portals by way of which a client, contractor and management entity may communicate and implement various functionalities;

FIG. 3 is a schematic view illustrating various aspects of an exemplary operating environment;

FIG. 4 is a schematic representation of a graphical user interface (GUI) or “user interface” (UI) illustrating aspects of an exemplary application form for use by a designer or contractor;

FIG. 5 is a schematic representation of a user interface illustrating aspects, such as various menu choices and links, of an exemplary menu/home page associated with a contractor or designer;

FIG. 6 is a schematic representation of a user interface illustrating aspects of an exemplary profile editing form for use by a designer or contractor;

FIG. 7 is a schematic representation of a user interface illustrating aspects of an exemplary form for use by a designer or contractor in editing various previously specified preferences;

FIG. 8 is a schematic representation of an exemplary user interface that permits a user to view all projects completed by contractors or designers in the group to which the user belongs;

FIG. 9 is a schematic representation of an exemplary user interface that permits a user to view the status and other information concerning various projects with which that user has been involved;

FIG. 10 is a schematic representation of an exemplary user interface that permits a user to view a listing of the various projects available to that user;

FIG. 11 is a schematic representation of an exemplary user interface that permits a user to view a listing of the various projects completed by that user;

FIG. 12 is a schematic representation of an exemplary user interface that illustrates various menu choices and links available to a user concerning exemplary logo and stationery projects available to that user;

FIG. 13 is a schematic representation of an exemplary user interface illustrating various menu choices and links available to a user concerning revision projects available to that user;

FIG. 14 is a schematic representation of an exemplary user interface concerning submission of completed work by a contractor or designer;

FIG. 15 is a schematic representation of an exemplary user interface concerning a peer ranking process;

FIG. 16 is a flow diagram indicating various general aspects of a process for submitting and managing work projects in a network environment;

FIG. 17 is a flow diagram that illustrates aspects of an exemplary process such as may be employed by a client to obtain designer services, and related products, in a network environment;

FIG. 18 is a flow diagram that illustrates aspects of an exemplary process such as may be employed by a designer to provide services such as artwork creation, and related products, to a client in, a network environment;

FIG. 19 is a flow diagram that illustrates aspects of an exemplary performance rating process suitable for employment in a network environment; and

FIG. 20 is a flow diagram that illustrates aspects of an exemplary peer review process suitable for employment in a network environment.

### DETAILED DESCRIPTION OF SELECTED EMBODIMENTS OF THE INVENTION

Reference will now be made to the drawings to describe various exemplary embodiments of the invention. It is to be understood that the drawings are diagrammatic and schematic representations of such exemplary embodiments, and are not limiting of the scope of the present invention in any way, nor are they necessarily drawn to scale.

The present invention relates generally to initiation, management and execution of work projects in a computer network environment. More particularly, embodiments of the present invention relate to systems, methods, and software for use in defining, implementing and managing economically efficient interactions and relationships between clients and a preselected group of contractors so as to facilitate execution, by the contractors, of work projects identified and requested by the clients.

I. General Overview of an Example Operating Environment

The following general discussion is directed to various exemplary relationships between the various entities or participants in association with which the functionality disclosed herein may be implemented. Such discussion further addresses general aspects of some exemplary operating environments for embodiments of the invention. In conjunction with the discussion of such exemplary operating environments, various operational aspects of embodiments of the invention are considered. However, a more detailed description of such operational aspects, and others, is provided following the aforementioned general discussion.

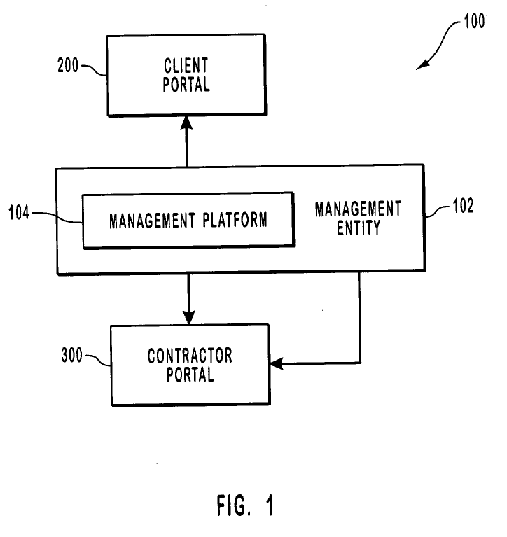

Directing attention now FIG. 1, details are provided concerning various aspects of exemplary participants, and associated relationships and interactions, such as may be implicated by embodiments of the invention. By way of example, at least some embodiments of the invention may be implemented in a form of a management services network (“MSN”), denoted generally at 100 in FIG. 1. By way of example, the MSN 100 comprises a management entity 102 that includes a management platform 104 configured and arranged to implement communications with, and between, a client portal 200 and a contractor portal 300. In at least some implementations, the management entity 102 may likewise be configured for indirect communication with the management platform 104 by way of contractor portal 300. Of course, various other relationships may be defined consistent with requirements of a particular application.

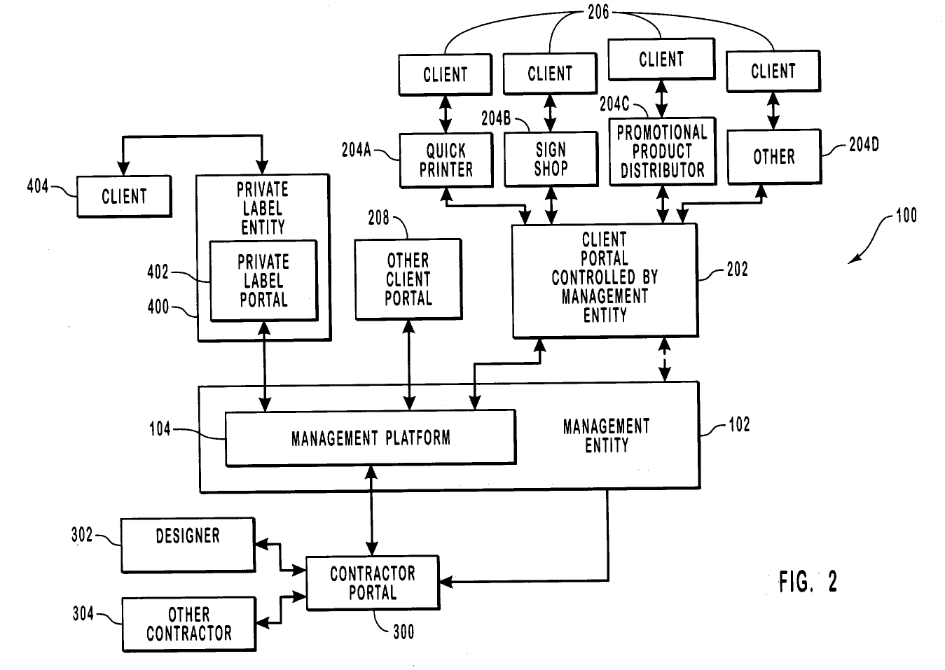

In general, the clients accessing the management platform 104 by way of the client portal 200 comprise any actual or prospective client desiring to enter into a relationship with one or more designers 302 and/or other contractors 304 (see FIG. 2), such as may access the management platform 104 by way of the contractor portal 300. Moreover, the designer 302 and other contractor 304 exemplarily comprise a predetermined group of designers approved by the management entity 102 or other entity.

It should be noted that the configuration of MSN 100 illustrated in FIG. 1 is exemplary only. For example, in some implementations, the management entity 102, the client portal 200 and the contractor portal 300, as well as management platform 104 may all be associated with a single business entity. This may be the case, for example, where the MSN 100 is implemented in the context of a computer network, such as a local area network (“LAN”). In yet another implementation, the management entity 102 may represent, or otherwise be associated with, one particular business entity, while one or both of the client portal 200 and the contractor portal 300 may be associated with one or more other distinct and separate business entities. Consistent with the foregoing, the scope of the invention should not be construed to be limited to any particular implementation of MSN 100.

With attention now to FIG. 2, further details are provided concerning various exemplary portals such as may be implemented and employed in connection with embodiments of the MSN 100. As in the case of the MSN 100 illustrated in FIG. 1, the illustrated embodiment of the MSN 100 depicted in FIG. 2 is generally configured and arranged so that the management entity 102, acting through the management platform 104, is effective in implementing and facilitating various relationships and interactions between various clients and contractors. As indicated in FIG. 2, the contractor portal 300 is configured and arranged to implement interactions between a designer 302 and/or other contractor 304, and various clients by way of the management platform 104. Moreover, the contractor portal 300 is also configured and arranged to facilitate communication between the management entity 102 and various clients by way of the management platform 104.

A wide variety of client portal configurations may be implemented in connection with embodiments of the MSN 100. In one implementation, the client portal is implemented within a private label entity 400 as a private label portal 402. An arrangement such as this, may prove useful where, for example, a business entity, desiring to exercise a degree of control over the relationship between its clients 404 on the one hand, and the management entity 102 and various designers 302 and contractors 304, on the other hand. In this exemplary implementation, the functionality afforded by way of the private label portal 402 may comprise but one aspect or element of a suite of functionalities offered by or through the private label entity 400.

In yet other implementations, a client portal 202 may be provided that is controlled either in part or in whole by the management entity 102. This type of implementation may prove useful in situations where, for example, the clients and contractors comprise subdivisions or other sub-entities or departments of the management entity 102. In this exemplary implementation, the management platform 104 largely implements its functionality within the confines of a single business entity, such as may occur in typical integrated arrangements.

Alternatively, while the client portal 202 can be controlled by the management entity 102, the client portal 202 may be configured and arranged to give various other business entities access to contractor services by way of management platform 104 and contractor portal 300. In the exemplary case where the MSN 100 is intended to facilitate interaction and relationships between designers 302 and various clients, some exemplary entities which may access the management platform 104 by way of the client portal 202 may include businesses 204 such as, but not limited to, a quick printer 204A, a sign shop 204B, and a promotional product distributor 204C, as well as various other businesses 204D.

As suggested in FIG. 2, such businesses 204 may comprise clients in their own right and/or may have their own associated clients who wish to avail themselves, at least indirectly, of the services provided by various designers 302 and other contractors 304. Such other clients are generally denoted at 206 in FIG. 2. Such client portal configurations and implementations are exemplary only and, various other types of client portals 208 may be configured and implemented as necessary to suit the requirements associated with the particular application. Accordingly, the scope of the invention should not be construed to be limited to the exemplary configurations illustrated in FIG. 2.

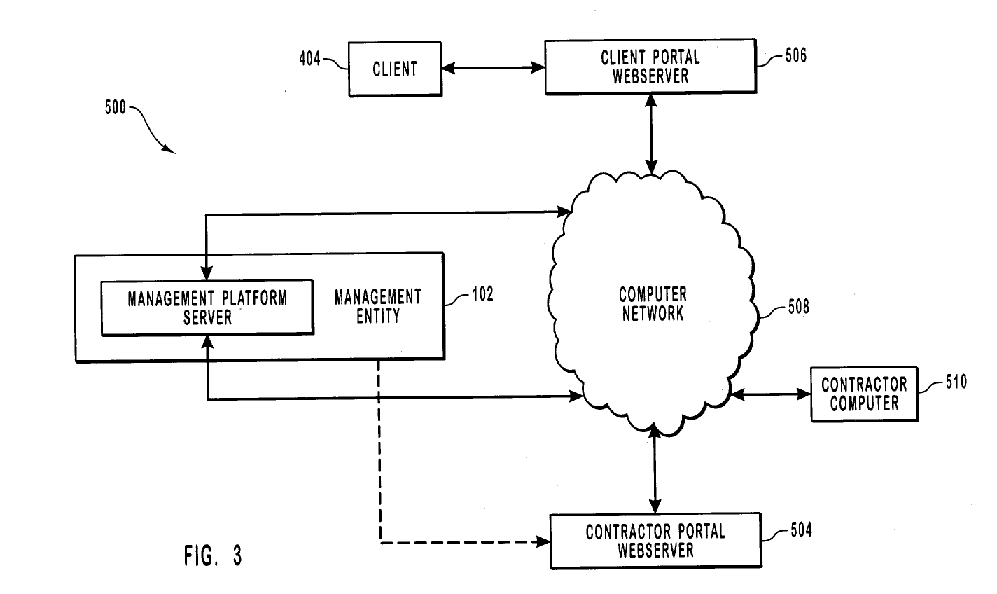

As suggested earlier, the embodiments of the invention may be implemented by way of a wide variety of systems, devices, hardware and software. With attention now to FIG. 3, details are provided concerning various aspects of an exemplary physical implementation of an MSN 100, denoted generally at 500, for implementing some or all of the functionality disclosed herein with respect to aspects of the MSN 100 and its components. Note that the aforementioned reference to a “physical” implementation of MSN 100 is not intended to, nor should be construed to be, limited to hardware such as systems and devices but may, more generally, comprise in a wide variety of combinations of hardware, software, systems, devices and computer executable instructions. In this regard, it should be noted further that the implementation illustrated in FIG. 3 should not be construed to limited the scope of the invention in any way.

With particular reference now to the MSN physical implementation 500 illustrated in FIG. 3, the management entity 102 includes a management platform server 502 configured for communication with a contractor portal web server 504 and a client portal web server 506 by way of a computer network 508. Exemplarily, the computer network 508 comprises a LAN or a wide area network (“WAN”). Alternatively, the computer network 508 comprises a global computer network such as the Internet.

As suggested in FIG. 3, the contractor portal web server 504 serves to make available one or more web pages of a contractor portal website that is accessible to contractors through the use of a contractor computer 510 in communication with the computer network 508. One useful aspect of such an arrangement is that so long as a contractor has a computer capable of communicating with a computer network 508, contractors located around the country or around world, as in the case where the computer network 508 comprises a global computer network, can enter into interactions and relationships with various clients 404 who are accessing the management platform server 502 by way of the client portable web server 506 and the computer network 508. Thus, embodiments of the invention are effective in implementing useful relationships and interactions between parties who may be located in geographically diverse locations.

II. Exemplary Aspects Concerning the Client and Contractor Portals and Various User Interfaces

As suggested earlier, at least some embodiments of the invention are suitable for use in promoting and facilitating various relationships and interactions between one or more designers and clients. In at least some implementations, the MSN 100 is configured to implement and facilitate interactions and relationships between a predetermined group of contractors and various clients. To that end, this exemplary embodiment of the invention provides for an application process whereby a designer or other contractor wishing to participate as a member of the MSN 100, and thereby provide services to various clients, must apply to become a member of an approved predetermined group of contractors. Such group of contractors may sometimes be referred to herein as ‘virtual’ group of contractors since, as noted earlier, contractors, as well as clients, may be in geographically diverse locations.

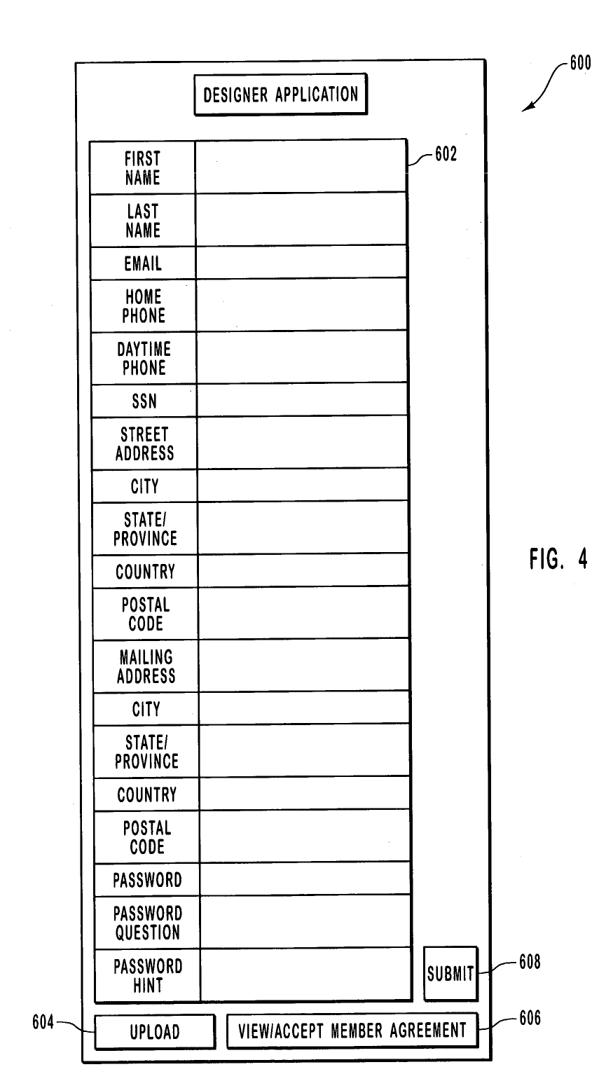

This application process, described in further detail elsewhere herein, is facilitated in part through the use of a “DESIGNER APPLICATION FORM” user interface (“UI”), denoted generally at 600 in FIG. 4. In this exemplary implementation, the DESIGNER APPLICATION FORM UI 600 is displayed on the contractor computer 510 (see FIG. 3) at such time as the contractor accesses the contractor portal web server (see FIG. 3). Generally, the DESIGNER APPLICATION FORM UT 600 comprises an online form 602 that requests information from the designer that will enable ready identification of the designer by the management platform 104 and/or the management entity 102.

As an example, information that may be requested from a prospective designer includes, but is not limited to, the first name, the last name, email address, home telephone number, daytime phone number, social security number, street address, city, state/providence, country, postal code, as well as a mailing address, city, state/providence, country and postal code. Additionally, the designer will be requested to supply a password, as well as a password question and a password hint that will enable the designer to logon to the system and in the event the designer has forgotten his or her password.

In addition to the aforementioned information fields, the exemplary DESIGNER APPLICATION FORM UI 600 further includes a “UPLOAD” button or link 604 that permits the prospective designer to upload to the management platform 104, various samples of work performed by the designer. More particularly, the designer may exemplarily upload two graphics files each of which, cannot exceed 800k in size. Such exemplary graphics files may include media types such, as but not limited to, graphic, flash, and MS Office, but generally exclude file types known to harbor viruses such as .vbs and .exe. types. In some implementations, the designer may also receive a message showing when the file type or size is not acceptable.

In addition to the aforementioned information fields and “UPLOAD” button 604, the illustrated embodiment of the DESIGNER APPLICATION FORM Ul 600 further includes a “VIEW/ACCEPT Member Agreement” button 606. Generally, the VIEW/ACCEPT Member Agreement button 606 requires a prospective applicant to read and accept a member agreement promulgated by the management entity 102 or other entity as a condition for consideration of the application of the designer. Finally, the illustrated embodiment of the DESIGNER APPLICATION FORM UI 600 includes a “SUBMIT” button 608 which permits the prospective designer to submit the information entered in the online form 602 upon completion of the application, but only after the prospective designer has viewed and accepted the member agreement.

In connection with the foregoing discussion of FIG. 4, it should be noted that the information fields, buttons and links, individually and collectively represent one exemplary implementation of a DESIGNER APPLICATION FORM UI. Accordingly, various other configurations of comparable functionality may alternatively be employed. Similarly, the designer application process may be facilitated or otherwise implemented with other vehicles and devices having functionality comparable to that implemented and/or represented by the designer application form UI 600.

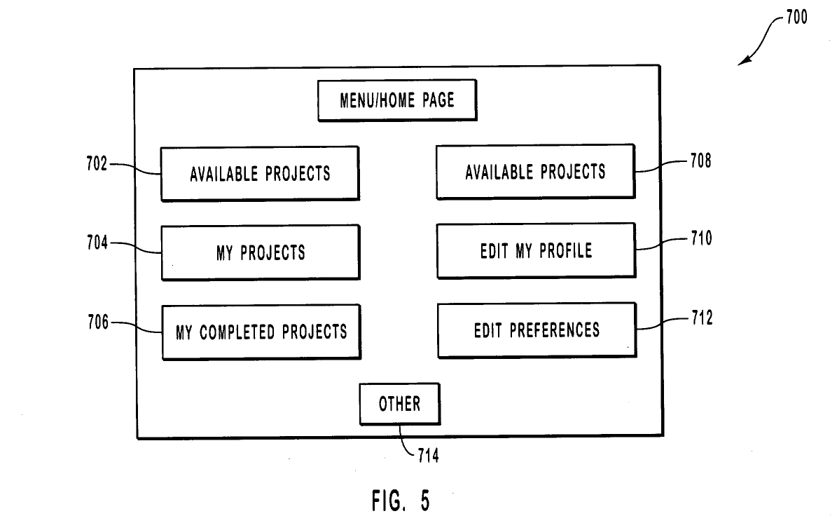

With attention now to FIG. 5, details are provided concerning a MENU/Home Page UI 700 such as may be presented to a designer through cooperation of the contractor computer 510 (see FIG. 3) with the contractor portal web server 504 (see FIG. 3). Generally, the MENU/Home Page UI 700 can be configured and arranged to include any of a wide variety of functionalities, depending upon aspects such as the needs of the designer, or other contractor, and the requirements for particular application. Accordingly, it should be understood that the exemplary configuration illustrated in FIG. 5 and discussed below is not intended to limited the scope of the invention in any way. Rather, any other combination of functionalities may alternatively be employed.

As indicated in FIG. 5, the exemplary MENU/Home Page UI includes a variety of buttons or links that implement, or facilitate the implementation of, various actions desired by the designer with whom the MENU/Home Page UT 700 corresponds. It should be noted that the immediately following discussion of the various buttons, links and other devices present on this exemplary MENU/Home Page UI 700 is limited primarily to general aspects of functionality of such buttons and a more detailed treatment of the functionality of various such buttons is considered elsewhere herein.

In the illustrated embodiment, one of the buttons included on the MENU/Home Page UI 700 is an “AVAILABLE PROJECTS” button 702 that, when selected by the designer or other contractor, provides a display of various client projects that are available to that particular designer. Generally, the list of projects available to any given designer is determined by the management platform 104 in accordance with various predetermined criteria and rules. By way of example, the list of available projects may be defined at least in part with reference to the expertise of the designer, wherein such designers may exemplarily be designated as a novice, expert or other level. Other criteria and rules could also be used, such as the performance of designer (based on previous projects), etc.

Additionally, the management platform 104 may be programmed or otherwise configured so that any given designer or a particular designer, may be permitted to work on only a certain predetermined number of projects at any given time. For example then, if a particular designer has seven projects on which that designer is committed to work, and the limit of projects for that designer is seven, the available projects button 702, when selected, will produce a corresponding display, such as a blank screen or message to the effect that the designer has reached his or her maximum number of projects. As yet another example, the available projects list may be determined, at least in part, with reference to the particular skills of a given designer. For example, if a particular designer specializes solely in floral designs, the list of available projects will not include any projects other than floral design projects.

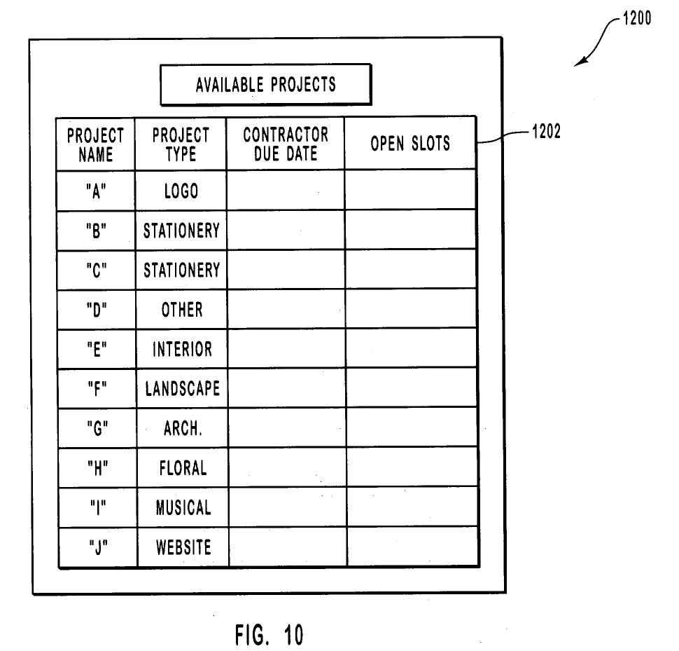

The aforementioned criteria for determining the scope and content of the AVAILABLE PROJECTS list displayed to a designer or other contractor are exemplary only and the available projects that may be displayed at any time to a particular designer or other contractor can be defined by any of a variety of other variables or combinations thereof. As another example, if a particular designer has failed to meet a delivery deadline for a particular project, it may be determined that no further projects will be made available to that designer until that designer completes the rest of his or her pending projects. Further details concerning the functionality associated with and implemented by way of the AVAILABLE PROJECTS button 702 is provided below in connection with the discussion of FIG. 10.

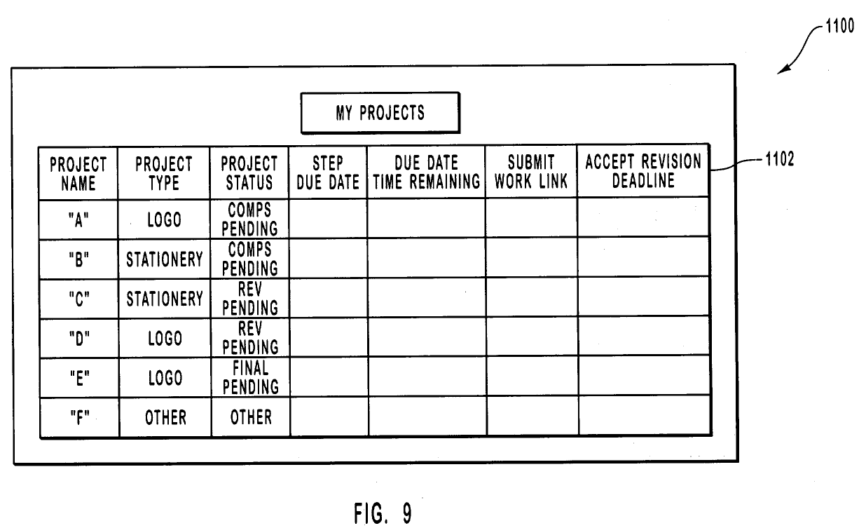

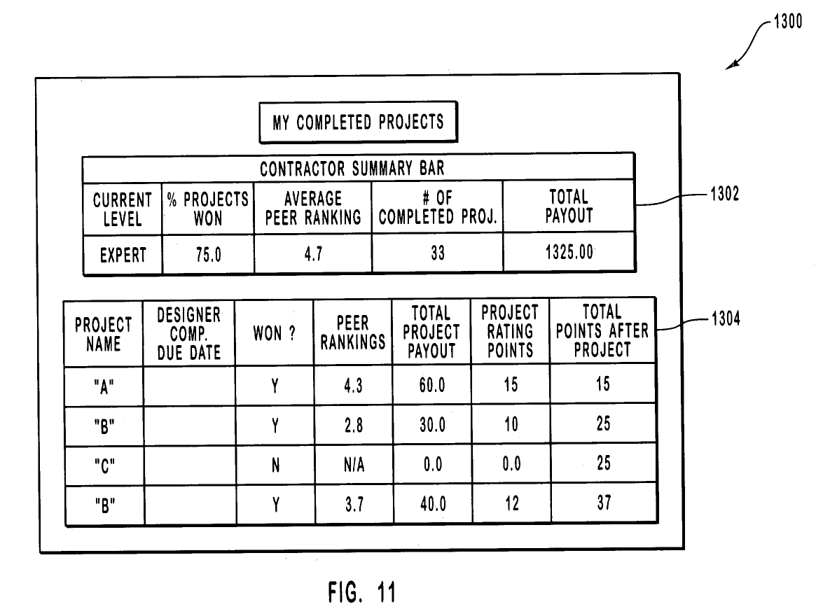

The exemplary menu/home page UI 700 further includes a “MY PROJECTS” button 704 that, in general, permits a particular designer to view tabular or other information concerning various projects with which that particular designer is then involved. Further details concerning the functionality implemented by way of and/or associated with the MY PROJECTS button 704 is provided below in connection with the discussion of FIG. 9. In similar fashion, a “MY COMPLETED PROJECTS” button 706 is provided that permits a designer to view, at a glance, an overall summary of various aspects concerning projects completed by that particular designer. In addition, the MY COMPLETED PROJECTS button 706 also permits the designer to view a line item summary of various aspects of each of the products completed by that designer to date. Further details concerning the functionality implemented by way of and/or associated with the MY COMPLETED PROJECTS button 706 are provided below in connection with the discussion of FIG. 11.

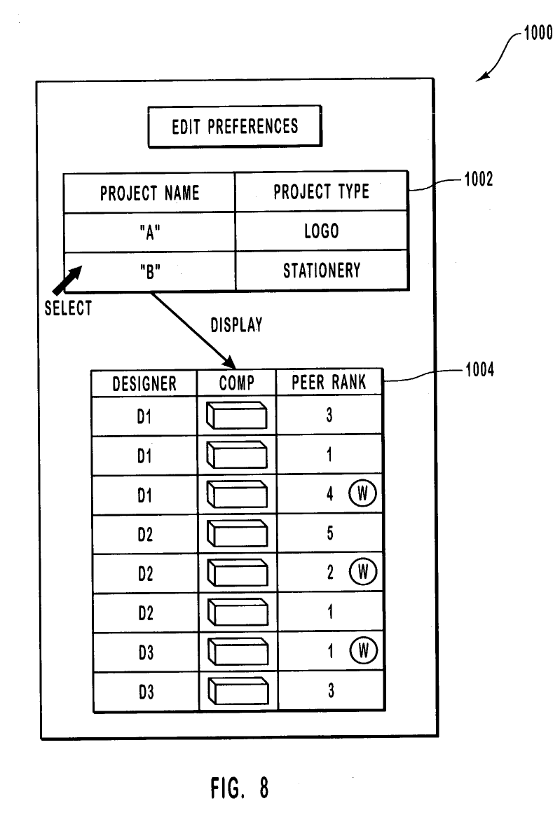

Further, related functionality is implemented or otherwise provided by way of “VIEW ALL COMPLETED PROJECTS” button 708. In general, this button permits a designer to view not only his or her completed projects, but all other projects completed by designers in the predetermined group of contractors or designers with which the designer is associated. Further details concerning an exemplary VIEW ALL COMPLETED PROJECTS UT and associated functionality are discussed below in connection with FIG. 8.

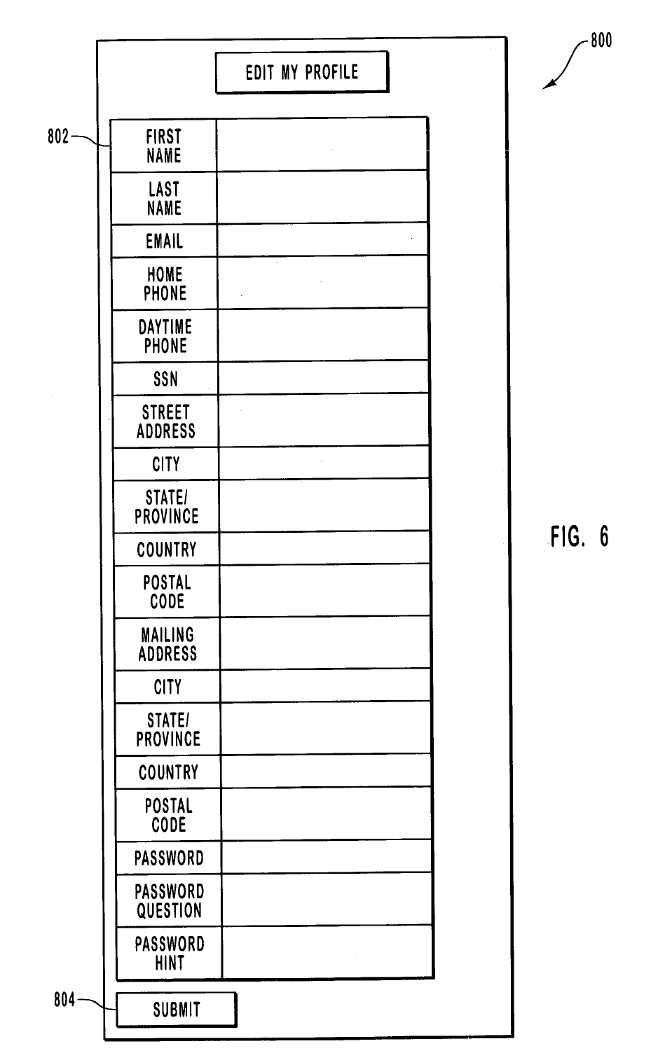

In addition to the aforementioned viewing and review functionality implemented by way of various buttons present on the exemplary implementation of the MENU/Home Page UI 700, yet other buttons or links may be provided that permit the designer to manipulate various data associated in some way with that designer. By way of example, the illustrated embodiment of the MENU/Home page UT 700 further includes an “EDIT MY PROFILE” button 710. In general, this button permits a user such as a contractor or designer to edit some or all of the information initially submitted in connection with the DESIGNER APPLICATION FORM whose sample UT is indicated at 600 in FIG. 4. Additional details concerning the functionality associated with the EDIT MY PROFILE button 710 is provided below in connection with the discussion of FIG. 6.

With continuing reference to FIG. 5, yet other editing functionality is afforded the designer or contractor by way of an “EDIT PREFERENCES” button 712. Generally, this button permits a user such as a designer or contractor to define and/or edit various preferences of the user concerning aspects such as, but not limited to, the form and manner of interaction between the designer and the management entity.

Finally, as indicated in FIG. 5, the exemplary MENU/Home Page UI 700 may include, facilitate and/or otherwise implement various other functionalities as well, as generally suggested by the “OTHER” button 714. Accordingly, and as noted earlier, the functionalities represented by the illustrated embodiment of the MENU/Home Page UT 700 are exemplary both in terms of the specific functionalities represented, as well as the combination thereof and are not intended to limit the scope of the invention in any way. Directing attention now to FIGS. 6 through 11, further details are provided concerning various aspects of the functionality associated with the various buttons or links illustrated in connection with the exemplary embodiment of the MENU/Home Page UI 700.

Turning now to FIG. 6, details are provided concerning aspects of an “EDIT MY PROFILE” UT, designated generally at 800. Generally, the EDIT MY PROFILE UT 800 permits the user to modify any of the user-specific information that was initially submitted in connection with the DESIGNER APPLICATION FORM UT 600 (see FIG. 4). Accordingly, the various fields 802 present in the EDIT MY PROFILE UI 800 substantially reflect the fields 602 that are presented in connection with the DESIGNER APPLICATION FORM UT 600. The illustrated embodiment of the EDIT MY PROFILE UI 800 further includes a SUBMIT button 804 which allows the user to submit the changes to the profile after such changes have been entered in the various fields 802.

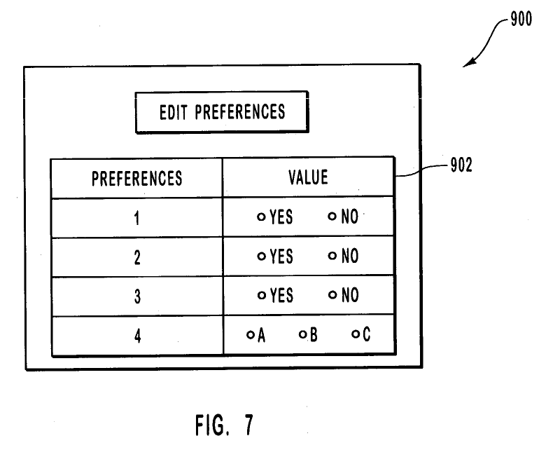

As noted earlier, at least some of the editing functionality afforded the user concerns various user preferences that can be set and modified as desired by the user. With attention now to FIG. 7, an exemplary “EDIT PREFERENCES” UT is denoted generally at 900. As suggested in the illustrated embodiment, the EDIT PREFERENCES UT 900 generally displays on or more particular preferences and allows the user to select a response or value corresponding to the desires of the user. As indicated in the preference table 902, the choices available to a user with respect to some preferences may be limited to specifying either “YES” or “NO.” In yet other cases, the user may specify a particular value instead of simply a YES or NO choice. Moreover, provision may be made for the setting of various defaults in connection with one or more preferences.

In general, the particular type and combination of preferences that can be defined and implemented with respect to a particular contractor or designer, is unlimited and can generally be selected as necessary to suit the requirements of a particular application and/or contractor. Examples of various preferences that may be defined and implemented so as to be variable by a user include, but are not limited to, the option for the designer to make his or her work available for review by recruiters and/or the option for the designer or contractor to allow their work to be presented to the relevant design or contractor community.

Yet other preferences that may be defined and implemented concern the relationship between the contractor or designer, and the management entity, for example. In this regard, preferences are defined that allow the user to specify whether or not the user desires to receive various announcements from and concerning the management entity, and also to specify whether or not the designer desires to receive a monthly news letter or other communication from the management entity or other entity. Of course, any of a variety of other or additional preferences may be defined and implemented as regards a particular contractor and/or group of contractors. Accordingly, the aforementioned preference examples and UI are not intended to limit the scope of the invention in any way.

As noted earlier, as least some implementations of the invention permit a designer or other contractor to view various aspects of projects completed by other designers or contractors with whom the viewing designer or contractor is associated. Directing attention now to FIG. 8, details concerning the viewing and displaying of such information are presented in the form of an exemplary “VIEW ALL COMPLETED PROJECTS” UI denoted generally at 1000. In general, the various projects that may be displayed in connection with the aforementioned VIEW ALL COMPLETED PROJECTS UI 1000 may be determined in a variety of different ways.

As an example, the VIEW ALL COMPLETED PROJECTS UI 1000 can be configured to list the last 100 projects where the client has selected a winning bidder and for which all peer rankings have been completed. Various other aspects, however, of the completed projects may be employed to determine which projects, if any, are displayed to a particular contractor or user. As indicated in FIG. 8, the VIEW ALL COMPLETED PROJECTS UI 1000 displays, among other things, a project brief table 1002 that, exemplarily, lists basic information about a completed project such as, but not limited to, the project name and project type. In the indicated example, the project brief table 1002 lists a logo project entitled “A,” as well as a stationery project entitled “B.” In this exemplary implementation, further details concerning a particular project listed in the project brief table 1002 can be displayed by simply selecting a particular project name. In the illustrated example, selecting project “B” causes a completed project display 1004 to appear on the screen.

In the illustrated example, the detailed information for project “B” comprises a completed project detail display 1004 that includes, among other things, all of the compositions or other bid materials that were submitted for that particular project, without regard to whether or not any particular one of such compositions was ultimately selected by the client as the winning composition. Exemplarily, the completed project detail display 1004 is sorted by designer name and displays, for each designer, each of the compositions submitted by that designer concerning project “B.” This display may include a full size version of the composition submitted by each designer or, alternatively, may display thumbnails linked to a full size version of the composition.

In addition to listing the designers and their corresponding submitted compositions or other bid materials, the completed project detail display 1004 also displays, for each composition, the rank assigned to that composition by the peers of the listed designer. As further indicated in FIG. 8, the completed project detail display 1004 also notes which compositions were selected by the client as winners for the displayed project. Of course, the project brief table 1002 and completed project detail display 1004 may be configured in a variety of other ways as well as necessary to suit the requirements of a particular application. In similar fashion, the VIEW ALL COMPLETED PROJECTS UI 1000 may be modified to include additional or alternative information. Accordingly, the implementation illustrated in FIG. 8 is exemplary only and is not intended to limit the scope of the invention in any way.

Yet another aspect of the exemplary MENU/Home Page UI illustrated in FIG. 5 is the ability of a particular contractor or designer to view at a glance all of the projects with which that contractor is then associated. Aspects of this functionality will now be considered in connection with the exemplary “MY PROJECTS” UT denoted generally at 1100 in FIG. 9. As indicated there, a projects table 1102 is provided that lists all pending projects for a particular designer. Note in this regard that other aspects of the embodiments of the invention provide for a display of all projects completed by a particular designer, as discussed in further detail below in connection with FIG. 11. Thus, projects table 1102 is exemplarily limited to those projects pending for a particular designer.

In the exemplary projects table 1102 indicated in FIG. 9, various information concerning each of the pending designer or contractor projects is provided. Such information includes, but is not limited to, the project name, project type, project status and the step due date. Generally, the step due date refers to the date when the next submission, whether a revision or initial submission, is due from the designer or contractor. The illustrated embodiment of the projects table 1102 further displays time remaining until the step due date so that the designer is made aware of how much time is left before the next submission is required.

The projects table 1102 further includes links or buttons that allow the designer to submit work for a particular project, as well as to accept a revision deadline defined by either the client or the management entity, or other party. Exemplarily, the information in the projects table 1102 is sorted by project name. However, it may prove useful to sort the information contained in the projects table 1102 according to various other schemes as well. By way of example, it may useful to the designer to have the projects table 1102 sorted by due date so that the designer can readily prioritize the various projects to which he or she is committed. Consistent with the foregoing, the content and arrangement of the project 1102 may be varied as necessary to suit the requirements for a particular application and, accordingly, the configuration illustrated in FIG. 9 is exemplary only and is not intended to limited the scope of the invention in any way.

As further indicated in FIG. 9, various project types may be illustrated in the projects table 1102 wherein such project types may include, but are not limited to logos and stationery. Moreover, various project statuses may likewise be defined and displayed. Some examples of such project statuses include, but are not limited to “compositions pending” which indicates that the designer, is currently working on compositions that have not yet been submitted. In yet another project status indicates “comps review” which means that the client is presently reviewing the submitted compositions. Similarly, statuses “revision pending” and “revision review” indicate, respectively, that the designer is working on revisions identified by the client and that revisions prepared and submitted by the designer are being reviewed by the client. In cases where design work is being preformed by in house staff of the management entity, an additional status “final pending” may be provided. It indicates that design is undergoing a “finalization” process by the in house staff. This can include a quality review of the design, as well as other steps relating to the management of the relationship between the designer and the client. This helps insure that a consistent product is delivered to the client, and negates the need for the freelancer to know exactly what deliverables need to be supplied to the client. For example, this step could be used to generate multiple file types of the design to insure that the client has multiple formats for using the design.

With respect to the step due date field, for example, it should be noted that in one embodiment, this field is applicable when the project status is in a “pending status.” Depending on the needs of the particular implementation, other links such as, but not limited to, the submit work link and the accept revision deadline lines can be displayed if applicable to the current status of the associated project.

With attention now to FIG. 10, details are provided concerning an “AVAILABLE PROJECTS” UI such as may be made available to the designer in connection with the display of the designer home page accessible by way of the contractor portal (see FIGS. 1 and 2). Generally, the particular projects displayed to a designer or contractor in connection with the AVAILABLE PROJECTS UI 1200 may be determined with reference to a variety of factors and variables including, but not limited to, the present work load of that particular contractor, the proficiency (for example, as would be determined by the “ranking” of the contractor) of the particular contractor and/or the particular type of project. Of course, other factors could also be used.

With relation to the last, the available projects table 1202 indicates that a variety of “PROJECT TYPE”s may be managed in connection with the implementation of embodiments of the invention. Such project types may include, but are not limited to, logos, stationery, interior designs, landscape designs, architectural designs, floral designs, musical compositions, website designs, brochures, yellow page advertisements and various other types of projects. More generally, it should be noted that embodiments of the invention are not constrained for use in connection with any particular type of project. Rather, embodiments of the invention are suitable for use in connection with any project that may be defined, executed and/or managed in connection with the functionality disclosed herein.

With continuing reference to FIG. 10, the available projects table 1202 further includes, in addition to the PROJECT NAME and PROJECT TYPE, the date that the initial set of compositions is due to be completed, and submitted by the contractor, or the “CONTRACTOR DUE DATE,” as well as the open slot that corresponds to rating levels the same as or below the rating level of the viewing designer, the “OPEN SLOT.” Thus, an AVAILABLE PROJECTS UT for an expert designer may display a somewhat greater number of projects than an AVAILABLE PROJECTS UI might display for a new designer, as the expert level designer can accept any project at or below his or her expertise level, while the beginning designer is limited to selection of slots designated only for beginning designers. Note that, in some embodiments, the OPEN SLOTS portion of the table not only list the slots that are available, such as mid or entry-level slots, but also whether or not the slot is filled.

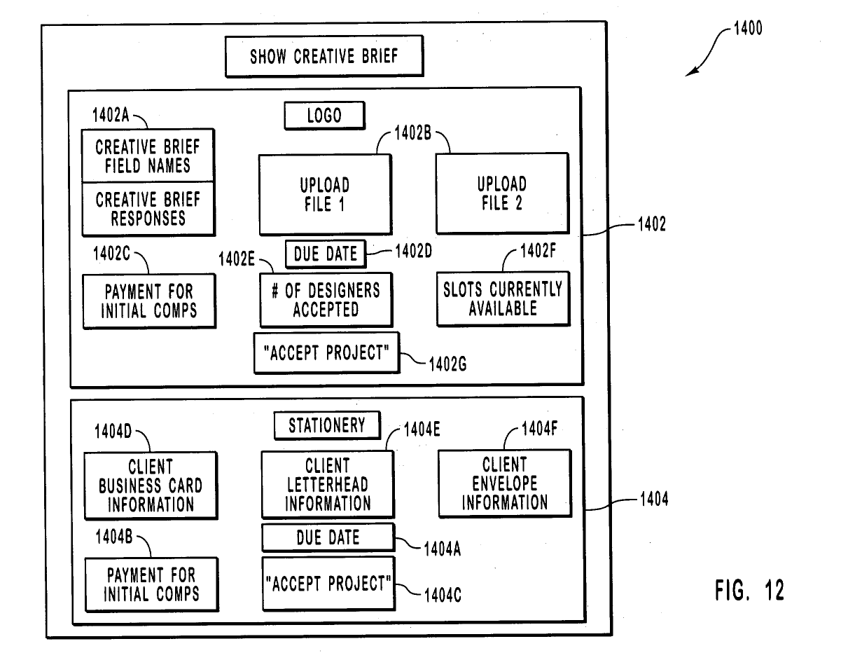

Exemplarily, the available projects table 1202 is sorted by the CONTRACTOR DUE DATE, however, the available projects table 1202 may be sorted in a variety of other ways as well. Finally, in this exemplary implementation, a designer or contractor may, by selecting a particular project name, such as by a double click, cause the display of the creative brief associated with that project. Further information concerning such displays is discussed below in connection with FIG. 12.

It was noted earlier that at least some of the embodiments of the invention provide the ability for a contractor or designer to view both the pending projects with which that designer is associated, as well as the projects that have been completed by that designer. With attention now to FIG. 11, details are provided concerning an exemplary composition and arrangement of information that may be made available to a designer or contractor concerning projects completed by that designer or contractor.

In this regard, a “MY COMPLETED PROJECTS” UI 1300 is indicated that displays, among other things, a contractor summary bar 1302 as well as a completed projects table 1304. With reference first to the contractor summary bar 1302, a brief overall summary is displayed concerning various projects that have been completed by the particular contractor or designer. Accordingly, the illustrated embodiment of the contractor summary bar 1302 displays, for example, the current proficiency level of that particular designer, the percentage of projects won by that designer as a percentage of the total number of projects that were bid on by that designer, the average ranking received by that designer from the peers of the designer, the number of the projects completed by that designer, as well as the total payout received by that designer. Thus, one aspect of the contractor summary bar 1302 is that the designer is able to see at a glance a distillation of various key pieces of information contained in or otherwise embodied by the completed projects table 1304.

With more specific reference now to the completed projects table 1304, the illustrated embodiment provides for the display of various aspects of each of the projects that have been completed by a particular contractor or designer. Exemplarily, the information in the completed project table 1304 is sorted by the project name, however, such information may be sorted in any of a variety of ways as well, as may be necessitated by the requirements of a particular application. For example, such information may alternatively be sorted by designer or ascending composition due date.

In addition to the project names, the completed projects table 1304 also includes, for example, the designer composition due date, whether or not the project was won by that designer, the peer ranking received by the designer for the particular submission, the total payout that the designer received for a given project, as well as the project rating points received by the designer for that project and a running total of the total points of the designer after completion of that project. As discussed in further detail elsewhere herein, the project rating points comprises a sum total of all the points received, or deducted, in connection with the peer rankings, as well as the points received, or deducted, in connection with the performance of the designer regarding that project. In this example, the total project payout includes payment received by the designer for the initial submission, as well as for subsequent revisions submitted by the designer, and any bonus payment the designer may have received for the project.

It was noted earlier that by double-clicking or otherwise selecting a particular project displayed in connection with the AVAILABLE PROJECTS UI 1200 and available projects table 1202, a contractor or designer could display and view the creative brief associated with the selected project. With attention now to FIG. 12, details are provided concerning an exemplary “CREATIVE BRIEF” UI 1400 that includes a logo creative brief display 1402 and a stationery creative brief display 1404. Of course, additional or alternative types of creative brief displays, consistent with a particular project type for example, may also be employed in connection with the embodiments of the invention. Such creative briefs, as well as the revision briefs discussed below, may be referred to herein more generally as a project request.

As noted earlier, the creative brief is generated by the client and generally describes, contains or otherwise embodies the desires of the client with respect to the particular project that the client desires to be performed. With reference first to the logo creative brief display 1402, a table 1402A of creative brief field names and corresponding creative brief responses is provided that generally contains information provided by the client in response to questions or inquiries posed by the management entity or other entity.

By way of example, one logo creative brief display requests input from a prospective client concerning, among other things, the name of the client company, whether and what tag line the client would like to include with the logo, the nature of the company or corporation, a description of the products and services of the company, and information as to whether or not the company already has an identity or logo design. Table 1402A further exemplarily requests information as to the website of the prospective client, the intended application(s) of the logo, information concerning the customers of the company, as well as the type of image the company desires to project. In addition, the table 1402A may also request information from the client concerning specifics as to the type of logo desired by the client, wherein such information may include a request as to whether the company would prefer a symbol or logo type, whether the company has color preferences for the requested logo design, whether there are particular elements that the company desires to have included, or not included, in the requested logo, whether the company has information concerning other logos that appeal to the client, and any other general information that the prospective client may wish to provide.

The foregoing list of information provided in connection with the creative brief field names and creative brief responses of table 1402A is exemplary only and the nature and composition of information requested from any particular client may vary according to the client and the needs of that client, as well as the requirements of a particular application. Accordingly, such exemplary lists should not be construed to limit the scope of the invention in any way.

In addition to the creative brief, field names and responses provided in table 1402A, the logo creative brief display 1402 further includes and/or displays any files 1402B that have been uploaded by the client, as well as any comments submitted by the client in connection with such files. Such uploaded files 1402B may comprise examples of logos that include features desirable to the client. The logo creative brief display 1402 further includes the PAYMENT amount field 1402C associated with submission of the initial compositions, or ‘comps’ as they are sometimes referred to herein, pertaining to the logo creative brief. Additionally, a DUE DATE field 1402D is provided that indicates the deadline for submission of the initial compositions.

The other information displayed in connection with the exemplary embodiment of the logo creative brief display 1402 specifies the number of designers field 1402E that have already accepted or committed to submit composition for the project defined by the logo creative brief display 1402. In connection with the foregoing, a SLOTS CURRENTLY AVAILABLE field 1402F is likewise displayed. As noted earlier, the slots available to the designer or contractor may be derived, at least in part, from the expertise level of the particular designer. Finally, the exemplary logo creative brief display 1402 further includes a “ACCEPT PROJECT” button 1402G that permits the designer or other contractor to accept the project if the designer so desires.

With continuing attention to FIG. 12, it was noted earlier that yet other types of creative briefs that may be displayed or otherwise presented in connection with exemplary embodiments of the invention include, among others, a stationery creative brief display 1404. Similar to the logo creative brief display 1402, the stationery creative brief display 1404 includes a DUE DATE field 1404A, a PAYMENT for initial comps field 1404B, as well as an “ACCEPT PROJECT” button 1404C.

However, the exemplary embodiment of the stationery creative brief display 1404 illustrated in FIG. 12 also differs somewhat from the logo creative brief display 1402 in that the stationery creative brief display 1404 includes various client information fields that generally contain information submitted by the client in connection with the particular types and forms of stationery desired by the client. Accordingly, the illustrated embodiment includes a CLIENT BUSINESS CARD INFORMATION field 1404D, a CLIENT LETTERHEAD INFORMATION field 1404E, and a CLIENT ENVELOPE INFORMATION field 1404F. As generally suggested by the foregoing, the various fields located within the stationery creative brief display and, more generally, within any creative brief display may be tailored as necessary to suit the requirements of a particular project and/or client.

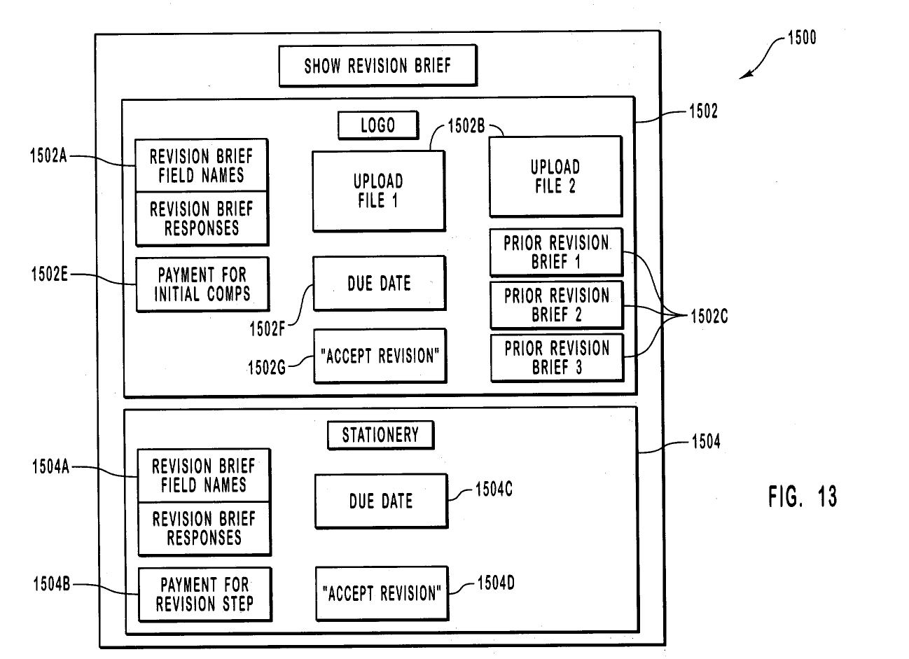

In connection with various creative briefs such as those discussed above with reference to FIG. 12, at least some embodiments of the invention likewise provide for the use of various revision briefs which, in general, permit a client to define various changes that the client desires to have implemented with respect to an initial composition or other material submitted by contractor such as the designer. With attention now to FIG. 13, exemplary logo and stationery revision brief displays are indicated. As indicated in FIG. 13, one or both of such revision briefs may be displayed or otherwise presented in connection with a REVISION BRIEF DISPLAY UI 1500 that exemplarily includes, among others, a logo revision brief 1502 and a stationery revision brief 1504.

With reference first to the logo revision brief 1502, a table 1502A of revision brief field names and corresponding revision brief responses is displayed. Generally the table 1502a contains revision brief field names that permit the client to specify the various changes desired by the client with respect to a composition that has been submitted by a designer. By way of example, a client may be able to specify a request revision of features such as the color, size, shape, and general composition of a submitted project. More generally, however, any feature of the submitted composition may be specified as available for change by the client.

Additionally, the logo revision brief 1502 may display or otherwise make accessible more files 1502B uploaded by the client, as well as any corresponding comments submitted by the client with the file upload. Another feature of the illustrated embodiment of the logo revision brief 1502 is that it contains or otherwise makes accessible links to prior revision briefs 1502C, as well as the original creative brief 1502D to which the logo revision brief 1502 pertains. Links to the actual compositions from all previous revision rounds and the initial compositions provide the designer with a visual history of work progression. Thus, a designer or other contractor can readily review the status and the history of the revisions pertaining to the particular project. Moreover, the source files for all previous revisions and compositions can be linked, or otherwise made accessible, so that elements from various revisions can be easily combined and/or revised by the designer.

As in the case of the logo creative brief display 1402, the logo revision brief 1502 includes a PAYMENT FOR REVISION STEP field 1502E that indicates the payment that will be associated with submission of the requested revision. Finally, the illustrated embodiment of the logo revision brief 1502 includes a DUE DATE field 1502F and an “ACCEPT REVISION” button 1502G that permits the designer to indicate acceptance of the requested revision.

With continuing attention to FIG. 13, aspects of one implementation of a stationery revision brief 1504 are indicated. In this exemplary implementation, the stationery revision brief 1504, similar to the logo revision brief 1502 includes, a table 1504a of revision brief field names and corresponding revision brief responses. The stationery revision brief 1504 also includes a PAYMENT FOR REVISION STEP field 1504B and a DUE DATE field 1504C. Finally, the illustrated embodiment of the stationery revision brief 1504 includes an “ACCEPT REVISION” button 1504D that permits the designer to commit to performance of the revisions requested by the client.

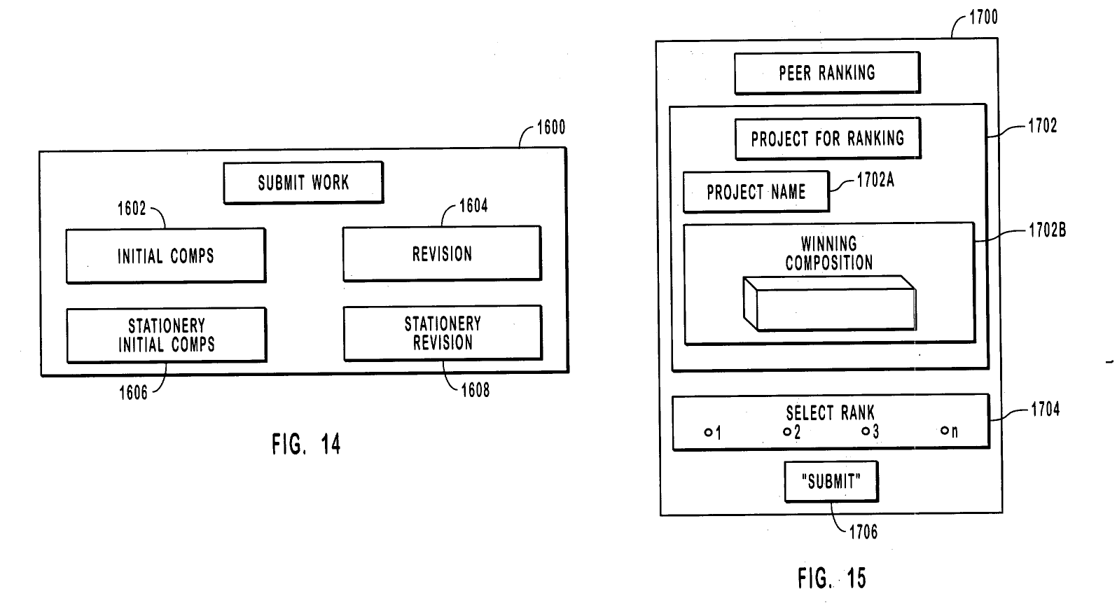

As noted earlier, with reference to FIG. 9 for example, a contractor or other designer will, at various times, be requested to submit work that has been completed by that designer, to the client, such as by way of the management platform 104. With attention now to FIG. 14, details are provided concerning various aspects of an exemplary “SUBMIT WORK” UI, generally denoted at 1600 in FIG. 14. As indicated there, the SUBMIT WORK UI 1600 provides for uploading initial compositions by way of the INITIAL COMPOSITION button 1602, submission of revisions by way of the REVISION button 1604, submission of stationery initial compositions by way of STATIONERY INITIAL COMPS button 1606, as well as the submission of stationery revisions by way of the STATIONERY REVISION button 1608. Corresponding initial submission and revision submission buttons may alternatively or additionally be supplied on the SUBMIT WORK UI 1600 for use in connection with various other types of projects as well.

Accordingly, the configuration and arrangement of the SUBMIT WORK UI 1600 illustrated in FIG. 14 is exemplary only and is not intended to limit the scope of the invention in any way. Further details concerning the specific uploading process are provided below in connection with the discussion of the various processes implemented in connection with embodiments of the invention. As noted earlier, the SUBMIT WORK UT 1600 may be accessed by way of a link present on another page or the home page of the designer. However, various other mechanisms may likewise be employed to implement the functionality disclosed herein.

Other aspects of exemplary embodiments of the invention relate to a peer ranking system by which various contractors within the group of predetermined contractors are given the opportunity to rate various aspects of work created by other contractors or designers in the predetermined group. Among other things, this type of peer ranking system provides valuable feedback to a user, which the user may then employ in furtherance of the implementation of improvements to his or her skills. Moreover, as the designer increases in skill and proficiency, the rating of that designer will change correspondingly. One result of an improved rating is that a designer with an expert rating, for example, will receive relatively greater payments for a given project than what a designer with a mid-level designer. Another useful aspect of the peer review system is that while the designer cannot generally be assured of objective input from the client, the anonymous reviews submitted by other designers give the designer a somewhat more objective idea of his or her performance. This type of “expert” opinion will often balance the client's end-user perspective, thereby resulting in more useful feedback to a designer.

Directing attention now to FIG. 15, details are provided concerning various aspects of an exemplary “PEER RANKING” UI denoted generally at 1700. In the illustrated embodiment, the PEER RANKING UI 1700 presents the designer with a display 1702 that includes a PROJECT NAME field 1702A, as well as a WINNING COMPOSITION display 1702B that either presents a full-size version of the winning composition or includes a link to a full-size version of the winning composition so that the peers of the designer can adequately assess the quality of the composition.

In addition to the display 1702, the PEER RANKING UI 1700 further includes a SELECT RANK display 1704 whereby the user is permitted to rank the displayed composition relative to other compositions displayed on the PEER RANKING UI 1700. It should be noted in this regard that while only a single winning composition displays 1702B is indicated in FIG. 15, in one example a typical PEER RANKING UI 1700 will display all compositions submitted for a particular project that has had a winning composition selected by the client. Alternatively, the peer ranking queue can display all compositions prior to the selection of a winner. In general, the displayed compositions are grouped by designer and, as noted earlier, the designer viewing the PEER RANKING UI 1700 will then be given the opportunity to rank the designers relative to each other. It should be noted in this regard that designers generally will not be able to rank their own compositions relative to the compositions of other designers. As further indicated in FIG. 15, the exemplary peer ranking UI 1700 further includes a “SUBMIT” button 1706 that allows the user to submit the specified composition rankings.

III. Aspects of Various Exemplary Processes and Interactions

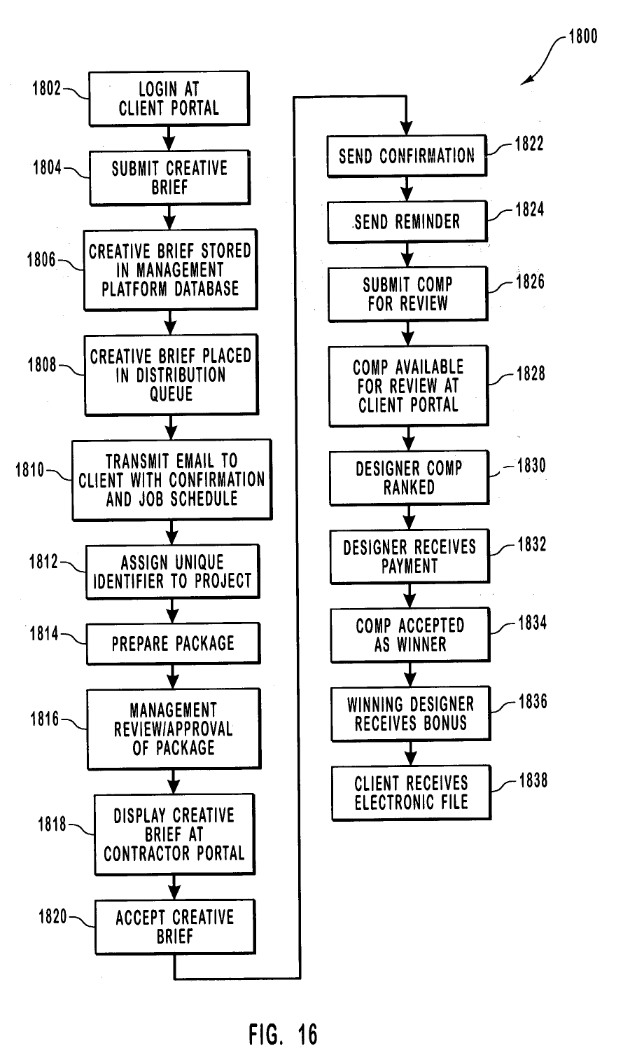

Directing attention now to FIGS. 16 through 20; various aspects of exemplary processes and associated functionality as may be performed or implemented in association with the embodiments of the invention will be considered. In that regard, the discussion of this section is initially directed to various functional aspects of exemplary embodiments of the invention, with specific attention being directed initially to exemplary functionalities associated with embodiments of the management platform (see FIG. 1).

In general, the management platform automates the management of the relationships u and interactions between clients and contractors. The management platform is concerned with, among other things, distributing work projects among the members of the virtual design team, the display and selection of candidate compositions, facilitating a revision process concerning various compositions prepared by contractors, collecting payment from clients and paying the contractors, implementing and facilitating a peer review system and a payment distribution system. As a result of the aforementioned, and other, functionalities, the management platform is able to act in cooperation with client and contractor portals to establish and maintain economically efficient relationships and interactions between clients and a virtual team of pre-selected contractors. In addition to facilitating the implementation of relationships and transactions between prospective clients and a pre-selected group of contractors, the management platform is also configured to allow and implement relationships and interactions between and among personnel associated with the management entity. In this way, the management platform allows for “active management” of the project on behalf of the client who may otherwise lack the expertise to personally direct the activity of freelance designers, such as would be the case where a relationship is formed via a “bulletin board” type of site.

As suggested by the discussion earlier of exemplary implementations and operating environments for the management platform, software and other materials for implementing the functionality of management platform may be configured in a variety of different ways and take a variety of different forms. By way of example, in some implantations the management platform comprise a modular software and/or hardware solution that can receive, for example, various client and contractor portals in connection with which embodiments of the invention are implemented. In some applications, such as in a LAN, for example, the management platform could be configured as a stand-alone application that can be deployed within a particular business entity or enterprise.

In at least some implementations, the management platform generally comprises a group of rule-based procedures that are used to implement the various aspects of the exemplary functionalities disclosed herein in connection with a management platform. As a result of this rule-based structure, the management platform is effective in automating a substantial portion of the various processes associated with the identification and execution of various work projects in a variety of operating environments. In this regard, the various client and contractor portals reflect the functionality and rule-based procedures embodied by the management platform, in the way in which they guide and interact with the clients and contractors.

In connection with the foregoing generalized functionalities, exemplary embodiments of the management platform include or otherwise embody a variety of particular functionalities that are useful in various circumstances. By way of example, the management platform is configured to collect and store data on each contractor that has been approved for participation. Additionally, the management platform permits notifications to be sent to the management of the business entity or other relevant entity when a new designer has applied to participate. In at least some implementations, the management platform performs, or otherwise causes the performance of, name-to-credit-card checks to verify the identity of new designers, and then stores that information in a database. In this way, the management platform is effective in ensuring that new designers are who they purport to be. In connection with the foregoing, the management platform also permits management personnel of the management entity to access candidate contractor information and also to activate particular contractors at such time as those contractors are then approved, as well as to deactivate contractors if necessary.

At least some exemplary embodiments of the management platform further include a rating algorithm which is used to establish and maintain a rating for each designer that is a member of the selected group of approved designers. In general, various events correspond to the addition or deduction of points from a designer rating. By way of example, if the designer is removed from a project slot for failing to provide compositions on time, a deduction is made from the rating of that designer. As another example, when the designer submits a composition that is selected by a client as the winner, a predetermined number of points are added to the rating to that designer.

Similarly, the peer ranking process discussed elsewhere herein causes points to be added to, or subtracted from, the designer rating. Generally, such changes to the rating are tracked in a database stored at the management platform so that a designer can view those changes as a function of time. In at least some implementations, the numerical rating of a designer will determine the classification of that designer as, for example, novice, midlevel, or expert. As discussed in detail elsewhere herein, such ratings play a role in determining the amount of compensation that the particular designer will receive for submitting compositions, submitting the winning compositions, and submitting revisions. As a result of these and other systems, the designer thus has an incentive to improve his or her performance.

The foregoing are exemplary functionalities of the management platform and, more generally, exemplary embodiments of the management platform may include these and/or other functionalities as well. Further details concerning aspects various functionalities of the management platform are provided below in connection with FIGS. 16 through 20.

With attention first to FIG. 16, details are provided concerning on exemplary implementation of a process 1800 for identifying and executing work projects in association with a management services network 100 (See FIG. 1) and MSN physical implementation 500 (See FIG. 3). As indicated there, the process initially enters stage 1802 where a client logs in at the client portal. At this stage, the client portal cooperates with the management platform to gather various types of information concerning the business of the client, as well as the desires of the client concerning a project that the client wishes to have completed. The culmination of this process is a definition of a creative brief. In general, a ‘creative brief’ refers to an aggregation of information supplied by the client for the purpose of providing direction for the creation of some type of product, such as artwork.

After a definition of the creative brief has been completed, the process 1800 advances to stage 1804 where the creative brief is transmitted from the client portal to the management platform. Exemplarily, the client also provides payment information, such as credit card number and expiration date, contemporaneously with submission of the creative brief.

In connection with stage 1804, clients may be given the opportunity or option of selecting a particular design package from a group of package options. As an example, a package option may be defined in terms of the number of designers that will participate in submitting compositions for the particular creative brief defined by the client. In one exemplary implementation, a ‘gold’ package may be offered that provides that three designers will participate in the submission of compositions and revisions for the concept identified by the client, and further provides that the client will be permitted to make or request to revisions to the initially submitted composition. As another example, a ‘platinum’ package is defined that includes five designers and allows for three revisions. The foregoing packages are exemplary only however, and are not intended to limit the scope of the invention in any way.

In connection with the aforementioned stages 1802 and 1804, it should be noted that the management platform and/or client portal should be configured or programmed such that the client is able to stop the process 1800 at any time after creating a login identification (“ID”) and password. Moreover, the programming or configuration should permit the client to return at a later time and login and resume the process 1800. The same is likewise true with respect to the definition of the creative brief. In this regard, it is provided in some implementations that when the client modifies his or her information, the particular modification, as well as the date and time of the modification and the requestor are stored in a log file located at, or accessible by way of the management platform.

With continuing reference now to FIG. 16, submission of the creative brief causes the process to advance to stage 1806 where the creative brief is received at the management platform and stored in a data based located there. The process 1800 then advances to stage 1808 where the received creative brief is placed in a distribution queue. Among other things, this stage involves, in some exemplary implementation, the assignment of the creative brief to a supervisor ‘list of projects.’ The supervisor can then assign a project manager to the project. In other implementations, assignment of the project manager may be performed automatically.

The process 1800 then advances to stage 1810 where the management platform generates and transmits an email to the client confirming a receipt of the creative brief and presenting a job schedule with various deadlines. As in the case of the other email communications implemented in connection with embodiments of the invention, the job schedule email may be transmitted directly to a client computer or, alternatively, may be transmitted to the client portal where it can be accessed by the client, using the client computer, such as is the case with web-based email systems. In at least some implementations, such deadlines are generated or defined based on the time at which the creative brief was submitted by the client, and assumes time frames based on business hours and business days.

As an example, business hours may be defined as 9:00 am to 5:00 pm Mountain Standard Time/Mountain Daylight Time. In similar fashion, business days may be defined as any Monday through Friday, but excluding national holidays. In one exemplary implementation, the client review deadline is three business days, or 24 business hours, after submission, by the contractor or designer, of the project requested by the client. In the event that, for example, such submission takes place outside of standard business hours, the client review deadline will begin to run commencing at the start of business hours on the next business day. By way of example then, projects that begin at 9:00 am on a particular business day should be due at 9:00 am on the fourth business day hence. Finally, in this exemplary implementation, the submission deadline for the designer or other contractor is two business hours prior to the client review deadline.

It should be noted in connection with the foregoing job schedule and deadlines, that such deadlines and time frames are exemplary only and are not intended to limit the scope of the invention in any way. More generally, any particular job schedule and deadline schedule or scheme for determining the same may be devised consistent with the requirements of a particular application.

After transmission of the email at stage 1810 of the process, the process advances to stage 1812 where the management platform performs, or causes the performance of, various processes which permit, among other things, tracking, packaging, and assignment of the creative brief received from the client. More particularly, at stage 1812, a unique identifier is a assigned to the project to enable tracking. At stage 1814, a design package concerning the creative brief is prepared. Among other things, this involves determining a number of designers to be assigned to the project. In addition to the identification of the number of designers, preparation of the package requested by the client may additionally include naming particular designers to the team, as well as identifying the number of revisions purchased initially a number of additional revisions purchased. At stage 1814, the assigned project manager for the project is also identified.

The process then moves to stage 1816 where the completed logo project or package is made available to management, such as personnel associated with the management entity, for review and approval. Upon such completion of such review and approval, the project is then ready for display to the designer or contractor community. Accordingly, the process then advances to stage 1818 where the project information, including the creative brief, is made available for review by way of the contractor portal.

At stage 1820, the management platform then allows eligible designers to fill open designer slots in the virtual design team, by permitting designers to accept the creative brief generated by the client. Upon acceptance by a suitable number of designers, the project can be indicated or displayed at the contractor portal such that information is presented showing that all slots for the particular project have been filled. Alternatively, the ability to change the designer level classification for each slot can be provided so as to adjust them according to the balance of the number of designers in each ranking level against the total number of available slots. For example, if a number of new designers are available, some mid-level slots might be changed to entry so as to allow the new designers to find open/available slots.

At this point, the process advances to stage 1822 where the management platform sends a confirmation email to each of the designers who have accepted slots concerning the creative brief. Exemplarily, the email includes at least the project name and the deadline for the designer to submit an initial set of compositions for the project. At stage 1824, the management platform transmits reminder emails to the designers in the event that the designers have not uploaded compositions pertaining to the accepted project. Exemplarily, the emails are generated automatically according to a clock or other timer at the management platform that is synchronized with, or includes as an input, the deadlines previously submitted to the client. The time of the reminder may be any suitable time frame. By way of example, the system may be configured to send email to the designer or designers six hours before the initial submission is due to the client.

At stage 1826, the compositions developed by the designers are uploaded to, and received by, the management platform for review by the project manager. After approval has been given by the project manager, the process advances to stage 1828 where an email is sent to the client indicating that the composition is available for review at the client portal.

At this point, the process advances to stages 1830 and 1832 where, respectively, the compositions submitted by the designer are subjected to a peer ranking process, and the designer receives payment for the composition submitted. Note that in a preferred implementation, ranking of a composition is not a requirement for payment since the ranking process may take several days. However, other conditions could be a pre-requisite for payment. For example, a designer may be required to first rank a previously submitted project from another designer prior to payment. As noted elsewhere herein, in an example embodiment the payment submitted to the designer is based at least in part upon the designer's rating as entry level, midlevel or expert, which levels are in turn based on the designer's points rating as determined by his or her adherence to deadlines and his or her peer reviews. Consistent with the foregoing, the data available by way of the MY PROJECTS UI is updated to indicate the status and various other aspects of the projects, and the AVAILABLE PROJECTS UI may likewise be updated as well. These, and other updates, disclosed herein may be performed in real time, or on some other basis.

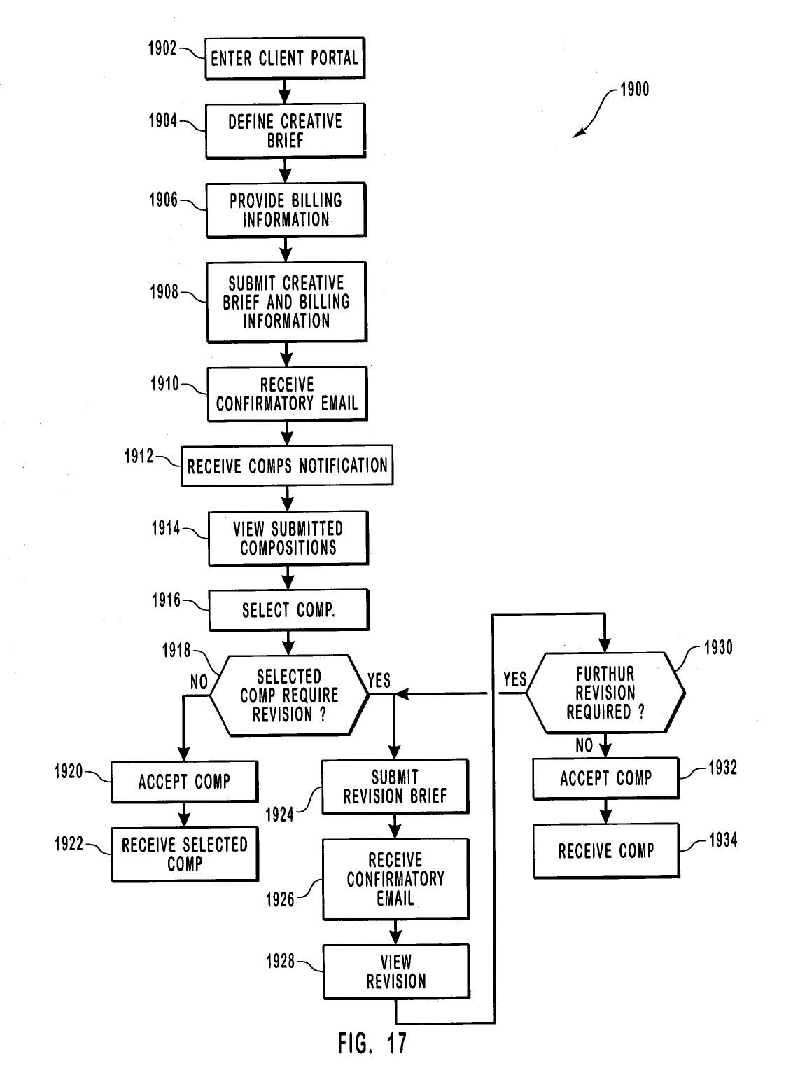

At stage 1834, the management platform permits the client to select one of the initially submitted compositions as the winner. In this regard, the client may select the composition as is or may specify further revisions that the client desires to be implemented with regard to the initial submission. Further details concerning the processes that occur when a client elects to implement further revisions are provided in connection with the discussions of FIGS. 17 through 19.

Upon acceptance of the initial composition by the client, the process 1800 advances to stage 1836 where the winning designer receives a bonus for having submitted the composition ultimately selected by the client as the winner. It should be noted in this regard that designers are paid for every revision and composition submitted pursuant to a particular project, whether or not such compositions and revisions are ultimately selected by the client as the winner. Finally, this exemplary implementation of the process 1800 terminates at stage 1838 where the client is permitted to download the graphics file generated by the designer. In some implementations, the client may further be permitted to submit comments with regard to the decision of the client as to the selection of the winning composition.

With regard to the preceding discussion, the process 1800 described in connection with FIG. 16 may generally be implemented in connection with the execution and management of a variety of different types of projects. Moreover, process 1800 may be modified as necessary to suit a particular type of project, application or operating environment. Accordingly, the scope of the invention should not be construed to be limited solely to the implementation of process 1800 illustrated in FIG. 16.

Directing attention now to FIG. 17, details are provided concerning a process 1900 which generally relates to various events concerning the management and execution of work project, as viewed from the perspective of a prospective client. As at least some of the stages in the process 1900 are similar to aspects of one or more stages illustrated in FIG. 16, the following discussion will focus primarily on certain selected differences between the processes illustrated in FIGS. 16 and 17, respectively.

At stages 1902 and 1904, respectively, the client enters the client portal and defines a creative brief, generally as disclosed elsewhere herein. Contemporaneously, the client provides billing information at stage 1906 and the process 1900 then advances to stage 1908 where the creative brief and billing information are transmitted from the client portal to the management platform.

At stage 1910, the client receives a confirmatory email indicating that the creative brief submitted by the client has been received at the management platform, and also providing a schedule of various deadlines pertaining to accomplishment of the work specified and defined by the client in the creative brief. The process then advances to stage 1912 where the client receives a notification email from the management platform indicating that compositions have been received from one or more designers and are available for review by the client. After the client has reviewed the compositions at stage 1914, the process advances to stage 1916 where the client selects from the submitted compositions, a composition as a winner.

At the decision point 1918 the client must then decide whether or not the client is satisfied with the composition as initially submitted or, more typically, whether the client desires to implement revisions to the selected composition. As noted elsewhere herein, the number of revisions that the client may request for implementation into the initially selected composition exemplarily depends upon the particular package that was purchased by the client. At decision point 1918, if the client determines that the selected composition does not require further revision, the process advances to stage 1920 where the client manifests acceptance of the composition. Exemplarily, such acceptance can be transmitted by email or other form. At stage 1922, the client then receives an electronic version of the winning composition.

If, on the other hand, the client determines at decision point 1918 that further revisions are required, the process then advances to stage 1924 where the client defines and submits a revision brief specifying changes desired by the client to be implemented with respect to the composition selected as the winner. At stage 1926, the client receives a confirmatory email indicating that the request for revisions has been received, and setting a project schedule for a completion of requested revisions. Upon completion and submission of the revisions by the designer, the process advances to stage 1928 where the client reviews the revisions. In one embodiment, an email is sent to the client indicating that revisions are ready for review.

Another decision point 1930 is then reached where the client must decide whether or not further revisions are required. If the client decides that no further revisions are required the process advances to stage 1932 where the client manifests acceptance of the revised compensation. The process then advances to stage 1934 where the client receives an electronic copy of the completed composition. On the other hand, if the client determines at decision point 1930 that further revisions are required after submission of the initial revision, the process then returns to stage 1924 and repeats itself until such time the client is satisfied with the revised composition and/or, the client has expended all of the revisions for which the client initially paid. At this point, the client may also decide to purchase additional revisions.

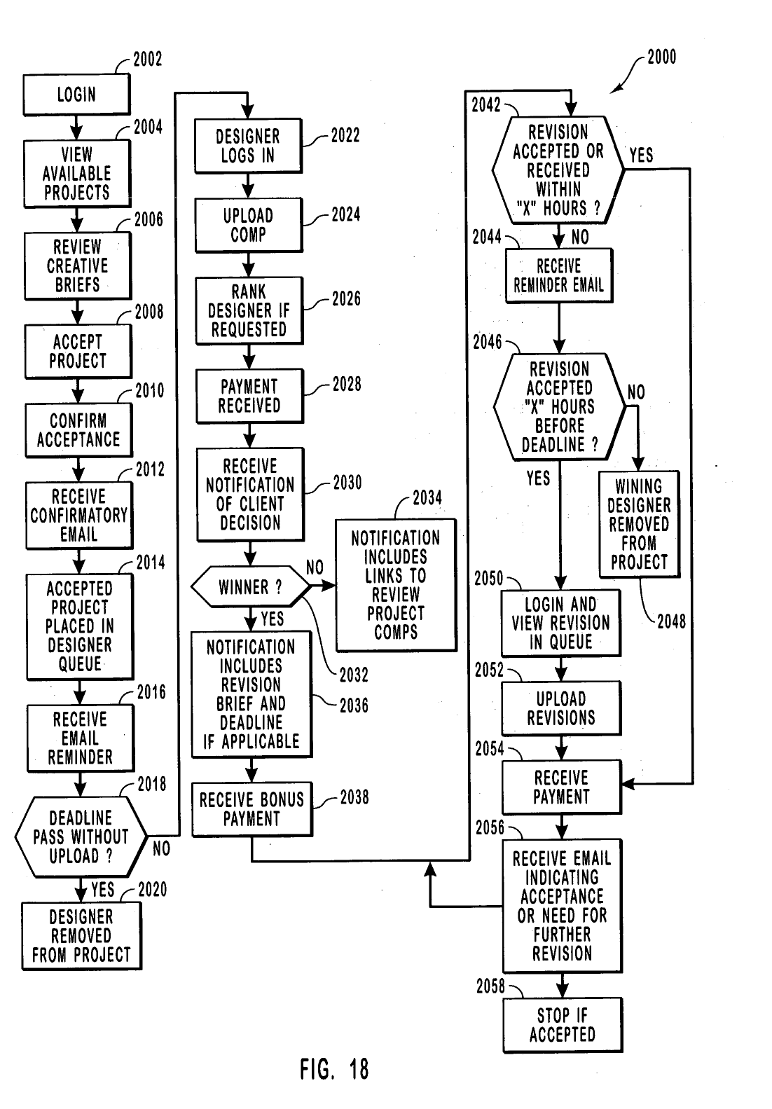

With attention now to FIG. 18, various aspects are indicated of a process 2000 that is directed to various stages in the work definition, execution and management processes, as view from the prospective designer. Initially, stage 2002 is entered where the designer logs in to the management platform by way of the contractor portal. The designer is then able to view available projects, at stage 2004, as well as review the associated creative briefs, at stage 2006.

At stages 2008 and 2010, respectively, the client indicates acceptance of a particular project, and confirms that acceptance for the management platform. Upon confirmation of acceptance to the management platform by the contractor, the process advances to stages 2012 when the designer or other contractor receives a confirmatory email from the management platform that indicates, among other things the various deadlines to which the designer must adhere concerning the accepted project. Subsequently, the process advances to stage 2014 where the accepted project is placed in the designer queue. The process then advances to stage 2016 where the designer receives an email reminder if the designer has not a uploaded initial compositions within a certain period of time prior to the deadline.

A decision point 2018 is then reached where, if it is determined that the decision point 2018 that the deadline has passed without the designer having uploaded compositions, the process advances to stage 2020 where the designer is removed from the project. At this time, or later, the designer rating is then subjected to a deduction of points for the designer having failed to meet the established deadline, and the overall designer rating is updated accordingly. In an alternative embodiment, a facility may be provided that allows the project manager to reinstate the designer and allow them to upload their work. For example, the ability to adjust the deadline by the project manager could be provided if the project manager finds that the designer has a mitigating circumstance for being late. The project manager could also remove the designer without a penalty, or apply the penalty at the project manager's discretion. This would be an example on one reason for providing a predetermined time difference between the designer deadline and the client deadline, i.e. to allow the project manager to contact the designer, make a decision, and find someone else to perform the design work if necessary.

If, on the other hand, the designer is diligent in preparing and uploading the requested compositions, the process 2000 would proceed generally as indicated beginning at stage 2022 where the designer logs into the management platform and then, advancing to stage 2024, uploads the art work requested by the client.

In connection with the uploading of compositions as suggested in stage 2024, various uploading schemes and file types that may be employed in this regard. In some implementations, the designer will be required to upload two individual files, such as a joint photographic experts group (“jpeg”) file and an encapsulated postscript (“.eps”) file, wherein the jpeg file will be displayed to the consumer and the .eps file will be archived. In the event that the client select the initially submitted concept without any revisions the .eps file will also serve as the final art work.

With regard to the properties of the jpeg file, embodiments of the invention provide for a requirement that the jpeg be 300 pixels in width×200 pixels in height, and should be rendered in the red/green/blue (“RGB”) mode. In at least some implementations, the RGB mode is required because many web browsers do not support the cyan/magenta/yellow/black (“CMYK”) mode. In such implementations, a jpeg saved in CMYK mode may be rejected by the management platform when the designer attempts to upload the file. The management platform may alternatively be configured to accept or reject various other types of files as well. At least some implementations, provision is made for permitting the designer to add explanatory comments in connection with the upload files.

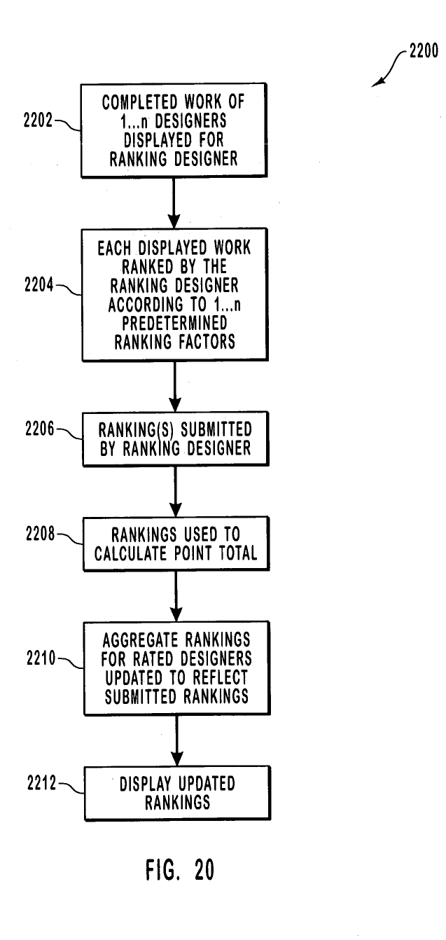

At some point after the uploading the compositions has occurred at stage 2024, the process advances to stage 2026 where the designer who has uploaded the compositions may be asked to rank the compositions of one or more other designers in the virtual group of pre-selected designers. Further details concerning the peer ranking process exemplified by stage 2026 are provided herein in connection with the discussion of FIG. 20.

After any peer ranking processes have been performed, the process 2000 advances to stage 2028 where the designer receives payment for having submitted the initial compositions. Subsequently, the process moves to stage 2030 where the designer is made aware of the decision of the client with respect to the composition(s) submitted by the designer. At decision point 2032, a determination is made as to whether or not the composition submitted by the designer has been selected as the winner by the client.

If the composition submitted by the designer has not been selected as the winner, the process advances to 2034 wherein a notification is sent from the management platform to the designer and includes links to review the other compositions submitted in connection with that project, including the winning composition. On the other hand, if it is determined that the composition submitted by the designer is the winning composition, the process advances to stage 2036 wherein the winning designer receives an email notification that includes a revision brief from the client, as well as a deadline for submitting the revision brief, if applicable. As noted earlier in this regard, there may be instances where the initial submission of the designer is accepted by the client without need for further revision. In any event, the process 2000 then advances to stage 2038 where the designer receives a bonus payment for having submitted the winning composition.

Subsequently, the process advances to stage 2040 where the designer logs in by way of the contractor portal and reads the revision brief submitted by the client in connection with the winning composition selected by the client. At decision point 2042, a determination is made at the management platform as to whether or not the winning designer has accepted the revision or whether the revision has been received from the winning designer by the management platform within a predetermined number of hours after the winning designer has received notification of having won. If the revision has not been accepted or received within such predetermined time frame, the process advances to stage 2044 and a reminder email is transmitted from the management platform to the designer.

On the other hand, if the designer has accepted the revision and/or submitted a revision within the predetermined time frame, the process advances to stage 2054 where the designer receives payment for having submitted the revision. Subsequently, the process advances to stage 2056 where the designer receives an email indicating acceptance of the revision by the client, or the need for further revision. In the event that a need for further revision is indicated in the status email, the process returns to stage 2040. If, on the other hand, the status email indicates that the revision has been accepted by the client and there is no need for further revision the process terminates at stage 2058.

A failure of the designer to submit a revision and indicate acceptance of the revision within the predetermined timeframe causes generation of a reminder email, after which the process advances to decision point 2046 where a determination is made as to whether or not revision has been accepted within a predetermined number of hours in advance of the deadline for submission to the client. If this, or other specified, criteria has been met by the designer, the process proceeds generally as described above with respect to stages 2054 through 2058.

If, however, the revision has not been accepted within this predetermined time frame, the process advances to stage 2048 where the winning designer is removed from the project and the rating of the winning designer is updated with a deduction, reflecting the fact that the designer has been removed from the project for failure to accept the revision in time. Also, a new designer could be added to the project at this point so as to insure that the revision is completed. If, on the other hand, the designer has accepted the revision within the predetermined time frame, the process advances to stage 2050 where the designer logs into the management platform by way of the contractor portal and views the revision brief in the queue.

At stage 2052, the designer prepares and uploads revisions consistent with the revision brief. Upon completion of the upload of the revisions, the process advances to stage 2054 where the designer receives payment for the revisions previously uploaded. At stage 2056, the designer then receives an email indicating an acceptance or the need for further revision. In the event that the client has accepted the revision, the process advances to stage 2058 and terminates. On the other hand, if the client has indicated that further revisions are required the process returns to stage 2040. It should be noted in connection with the foregoing discussion of stages 2050 through 2054 that if the answer at decision point 2042 is “YES,” it is implicit that the designer has performed the various processes suggested by stages 2052 through 2054.

IV. Aspects of Exemplary Evaluation Processes

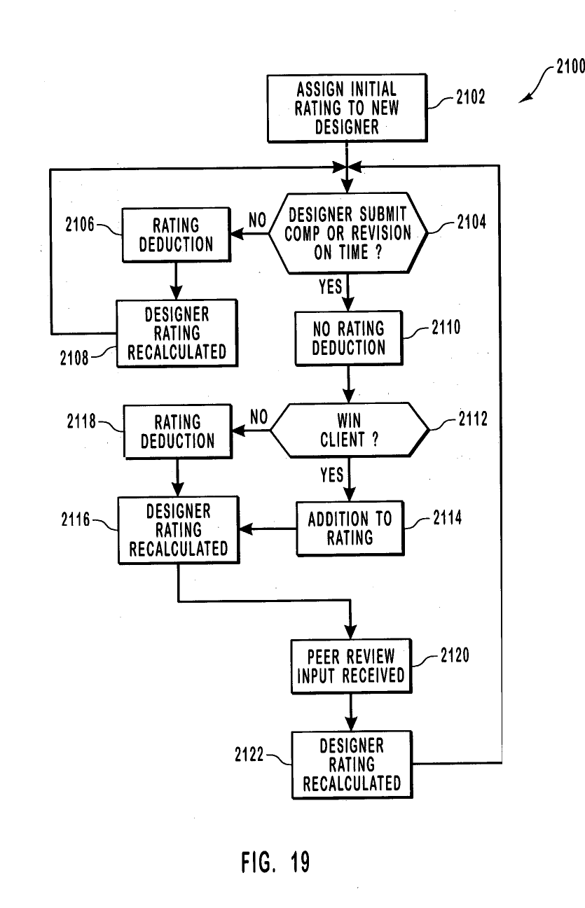

It was noted earlier that one aspect of exemplary embodiments of the invention is that provision is made for rating the performance of various contractors in the virtual group of pre-selected contractors. Accordingly, attention is directed now to FIG. 19 where aspects of a performance rating process 2100 are indicated. At the initial stage 2102 of the process, an initial rating is assigned to a new designer upon approval of the designer for inclusion in the pre-selected group of designers by the project manager. Typically, the initial rating is the same for each new designer regardless of the experience or qualifications of that designer. In one exemplary implementation, the overall point scale for designer ratings ranges from zero to 100 and the initial rating is thirty points. In general, no further action occurs until such time as the designer has committed to submit either a composition, revision, or other product, by a particular specified deadline.

At such time as the designer or other contractor has made the commitment to submit such a product, decision point 2104 is reached. If the designer fails to submit the composition or revision on time, the process advances to stage 2106 where a predetermined deduction is made from the rating of the designer. At stage 2108 of the process, the rating of the designer is then recalculated to reflect the deduction, and the process returns to decision point 2104.

It should be noted in this regard that a designer generally will not be permitted to miss an indefinite number of deadlines and, at some point, such as when the designer rating falls below a predefined minimum threshold, the designer relationship with the management entity or other entity will be terminated. One aspect of this invention is thus that chronic nonperformance of obligations is generally foreclosed, thereby enhancing the overall reliability of the system and providing for improvement and maintenance of customer satisfaction.

If, on the other hand, it is determined at decision point 2104 that the designer has submitted the composition or revision on time the process advances to stage 2110 where the determination is made that no deduction will be made from the designer rating. At such time as the designer has submitted the composition, or revision, on time, a determination is then made at stage 2112 as to whether or not the submitted design has been designated as the winner by the client.

If the composition or revision submitted by the designer has been selected as the winner, the process advances to stage 2114 where a predetermined addition is made to the designer rating. The magnitude of the addition made at stage 2114 can be indexed in a variety of ways. By way of example, an expert level designer may receive a greater addition to his or her rating than a midlevel or entry level designer would receive for having submitted the winning composition. On the other hand, the process may be implemented in such a way that the addition to the rating as a result of having won the client is the same in every case, i.e., bonuses would be the same regardless of designer rating, and a penalty would be relatively higher for a higher rated designer. After the addition has been made to the rating, the process then advances to stage 2116 where the designer's rating is recalculated.

On the other hand, if the designer has submitted the composition or revision on time but has nonetheless failed to have that composition selected as the winner by the client, the process advances from decision point 2112 to stage 2118, where a deduction is made from the rating of the designer. The process then continues to stage 2116 where the designer rating is recalculated.

Notwithstanding the opinion and analysis of the client concerning the product submitted by a particular designer or contractor, it may be the case that the product submitted by the designer is nonetheless of sufficiently high quality or artistic proficiency that the designer should be recognized for his or her efforts. Accordingly, a peer review process is provided that is represented by stage 2120.

Further details of the peer review process are provided below in connection with the discussion of FIG. 20. In general however, the peer review process involves a review by one or more of the designer peers and the submission of peer ratings concerning the work submitted by the designer. As in the case of other adjustments that may be made to the rating of the designer, the peer review may result in a positive, negative or zero number that is incorporated into the overall rating of the designer. Accordingly, after the peer review input has been received at stage 2120, the process advances to stage 2122 where the designer rating is recalculated. The process then returns to decision point 2104.

As noted above, one aspect of the designer performance rating system is that it takes into account input provided by the peers of a designer concerning the product submitted by that designer. With attention now to FIG. 20, further details are provided concerning an exemplary implementation of a peer review process. At the initial stage 2202, a reviewing designer is presented with a display of the completed work of one or more designers for ranking by the reviewing designer. Stage 2202 may be entered at any time and, exemplarily, is entered according to a schedule or time frame determined by the management platform with reference to the occurrence of other events, such as, but not limited to, the submission of a composition, revision or other work by the reviewing designer.

As will be indicated by the display of the completed work of the designers whose work is to be reviewed, each displayed work is to be ranked from highest to lowest according to various predetermined factors. Exemplarily, such factors include, but are not limited to, response of the designer with respect to the creative brief defined by the client, the creativity exhibited by the designer, and the professionalism exhibited by the designer. Thus, stage 2204 is entered where the reviewing designer specifies the ranking of the viewed projects according to such factors.

After the ranking designer has specified the rankings, the process advances to stage 2206 where the ranking designer submits his or her rankings of the displayed works. At stage 2208, the rankings submitted by the reviewing designers are used to calculate point totals for each of the designers whose work was evaluated. This stage of process 2200 may be implemented in a variety of different ways. As an example, on a project that includes three designers, the artist ranked at the top by the reviewing designers will receive +4 points, while the middle artist will receive zero and the lowest ranked artist −4 points. This way, a rated designer may receive point additions or deductions, or no changes, depending upon the opinion of the peers of that designer with respect to the work of that designer.

After the point totals have been derived from the rankings specified by the reviewing designer(s), the process advances to stage 2210 where the aggregate or overall ratings for each of the rated designers are updated to reflect the point totals implicated by the rankings submitted by the reviewing designer(s). Finally, the process advances to stage 2212; where the updated rankings are then displayed and available for review by the designers.

V. Aspects of Exemplary Hardware and Software, and Associated Configurations

As suggested earlier, embodiments of the present invention may be implemented in connection with environments that include a variety of systems, devices, hardware and software. More detailed information is now provided concerning exemplary hardware and software, and related configurations, that may be used to implement one or more aspects of embodiments of the invention. Embodiments within the scope of the present invention also include computer-readable media for carrying or having computer-executable instructions or electronic content structures stored thereon. Such computer-readable media can be any available media which can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium which can be used to carry or store desired program code means in the form of computer-executable instructions or electronic content structures and which can be accessed by a general purpose or special purpose computer.

When information is transferred or provided over a network or another communications connection (either hardwired, wireless, or a combination of hardwired or wireless) to a computer, the computer properly views the connection as a computer-readable medium. Thus, any such connection is properly termed a computer-readable medium. Combinations of the above should also be included within the scope of computer-readable media. Computer-executable instructions comprise, for example, instructions and content that cause a general purpose computer, special purpose computer, or special purpose processing device to perform a certain function or group of functions.

The following discussion is intended to provide a brief, general description of an exemplary computing environment in which the invention may be implemented. Although not required, aspects of the invention may be described in the general context of computer-executable instructions, such as program modules, being executed by computers in network environments. Generally, program modules include routines, programs, objects, components, and content structures that perform particular tasks or implement particular abstract content types. Computer-executable instructions, associated content structures, and program modules represent examples of the program code means for executing steps of the methods disclosed herein. The particular sequence of such executable instructions or associated content structures represent examples of corresponding acts for implementing the functions described in such steps.

Of course, the invention may be practiced in network computing environments with many types of computer system configurations, including personal computers, hand-held devices, multi-processor systems, microprocessor-based or programmable consumer electronics, network PCs, minicomputers, mainframe computers, and the like. The invention may also be practiced in distributed computing environments where tasks are performed by local and remote processing devices that are linked (either by hardwired links, wireless links, or by a combination of hardwired or wireless links) through a client network. In a distributed computing environment for example, program modules may be located in both local and remote memory storage devices.

The described embodiments are to be considered in all respects only as exemplary and not restrictive. The scope of the invention is, therefore, indicated by the appended claims rather than by the foregoing description. All changes which come within the meaning and range of equivalency of the claims are to be embraced within their scope.

What is claimed is:

1. A method for managing work in a computer network that includes a management platform accessible by way of a client portal and a contractor portal, the method comprising:
transmitting a project request to the management platform by way of the client portal;
receiving the project request at the management platform;
making the project request available to a preselected group of contractors;
transmitting a project acceptance to the management platform by way of the contractor portal, the project acceptance corresponding to the project request;
receiving the project acceptance at the management platform;
transmitting a product to the management platform by way of the contractor portal, the product corresponding to the project request; and
receiving the product at the management platform; and
making the product available to the client, on a predetermined basis, by way of the client portal.

2. The method as recited in claim 1, further comprising defining the project request at the client portal.

3. The method as recited in claim 1, wherein the project request comprises one of: a creative brief; and, a revision brief.

4. The method as recited in claim 1, wherein making the project request available to a preselected group of contractors comprises making the project request accessible by way of the contractor portal.

5. The method as recited in claim 1, further comprising receiving payment from a client, by way of the client portal.

6. The method as recited in claim 1, further comprising remitting payment to a contractor for the product.

7. The method as recited in claim 1, further comprising using one or more predetermined rules to generate a job schedule concerning the project request.

8. The method as recited in claim 1, further comprising providing reminders concerning the project request.

9. The method as recited in claim 1, further comprising providing status updates concerning the project request.

10. A method for managing work in a computer network that includes a management platform accessible by way of a client portal and a contractor portal, the method comprising:
receiving, by way of the client portal, a project request at the management platform;
making the project request available to a preselected group of contractors;
transmitting a plurality of project acceptances to the management platform by way of the contractor portal, the plurality of project acceptances corresponding to the project request;
receiving the plurality of project acceptances at the management platform;
transmitting a plurality of products to the management platform by way of the contractor portal, each of the plurality of products corresponding to a respective project acceptance; and
receiving the plurality of products at the management platform; and
transmitting the plurality of products to the client portal.

11. The method as recited in claim 10, wherein making the project request available to a preselected group of contractors comprises making the project request accessible by way of the contractor portal.

12. The method as recited in claim 10, further comprising receiving payment from a client, by way of the client portal.

13. The method as recited in claim 10, further comprising remitting payment to a contractor for one of the plurality of products.

14. The method as recited in claim 10, further comprising using one or more predetermined rules to generate a job schedule concerning the project request.

15. The method as recited in claim 10, further comprising providing reminders concerning the project request.

16. The method as recited in claim 10, further comprising providing status updates concerning the project request.

17. The method as recited in claim 10, further comprising receiving, from the client portal, input from the client indicating the product selected by the client.

18. A method for managing work in a computer network that includes a management platform accessible by way of a client portal and a contractor portal, the method comprising:
presenting, to a preselected group of contractors, a project request, the project request having been initiated at the client portal and presented at the contractor portal;
receiving, at the contractor portal, a plurality of project acceptances corresponding to the project request;
receiving, at the contractor portal, a plurality of products, each of the plurality of products corresponding to one of the plurality of project acceptances; and
transmitting the plurality of products to the management platform.

19. The method as recited in claim 18, further comprising receiving at least one reminder concerning at least one of the plurality of project requests.

20. The method as recited in claim 18, further comprising receiving at least one status update concerning at least one of the plurality of project requests.

21. The method as recited in claim 18, further comprising receiving input from the client indicating the product selected by the client.

22. The method as recited in claim 18, wherein the project request comprises one of: a creative brief; and, a revision brief.

23. The method as recited in claim 18, further comprising receiving, at least indirectly, peer review input from at least one of the contractors of the preselected group of contractors.

24. The method as recited in claim 18, further comprising receiving, at least indirectly, performance rating information concerning at least one of the contractors of the preselected group of contractors.

25. A method for requesting and obtaining a product in a computer network that includes a management platform accessible by way of a client portal and a contractor portal, the method comprising:
receiving, at the client portal, input from a client;
generating, at the client portal, a project request corresponding to the input received from the client;
transmitting the project request to the management platform; and
receiving, at the client portal, a product corresponding to the project request, the product having been generated by at least one contractor of a preselected group of contractors authorized to interact with the client by way of the management platform.

26. The method as recited in claim 25, wherein the project request comprises one of: a creative brief; and, a revision brief.

27. The method as recited in claim 25, further comprising receiving payment information from a client.

28. The method as recited in claim 27, further comprising transmitting the client payment information to the management platform.

29. The method as recited in claim 25, further comprising receiving a status update concerning the project request.

30. The method as recited in claim 25, further comprising receiving a project schedule concerning the project request.

31. The method as recited in claim 25, further comprising receiving a confirmation email concerning the project request.

32. The method as recited in claim 25, further comprising receiving a notification that the product is available for review by the client.

33. A method for managing the performance of work in a computer network that includes a management platform accessible by way of a client portal and a contractor portal, the method comprising:
receiving, at the management platform, a project request from the client portal;
transmitting the project request to the contractor portal for presentation to a preselected group of contractors;
receiving, at the management platform, a project acceptance corresponding to the project request, the project acceptance having been transmitted from the contractor portal;
receiving, at the management platform, a product corresponding to the project acceptance; and
transmitting the product to the client portal.

34. The method as recited in claim 33, further comprising receiving payment information from a client.

35. The method as recited in claim 33, further comprising remitting payment to a contractor.

36. The method as recited in claim 33, further comprising using one or more predetermined rules to generate a job schedule concerning the project request.

37. The method as recited in claim 33, further comprising providing to a contractor a reminder concerning the project request.

38. The method as recited in claim 33, further comprising providing a status update concerning the project request.

39. A computer program product for implementing a method for managing and executing work in a computer network that includes a management platform accessible by way of a client portal and a contractor portal, the computer program product comprising:
a computer readable medium carrying computer executable instructions for performing the method, wherein the method comprises:
presenting, to a preselected group of contractors, a project request, the project request having been initiated at the client portal and presented at the contractor portal;
receiving, at the contractor portal, a plurality of project acceptances corresponding to the project request;
receiving, at the contractor portal, a plurality of products, each of the plurality of products corresponding to one of the plurality of project acceptances; and
transmitting the plurality of products to the management platform.

40. The computer program product as recited in claim 39, wherein making the project request available to a preselected group of contractors comprises making the project request accessible by way of the contractor portal.

41. The computer program product as recited in claim 39, further comprising receiving payment from a client, by way of the client portal.

42. The computer program product as recited in claim 39, further comprising remitting payment to a contractor for one of the plurality of products.

43. The computer program product as recited in claim 39, further comprising using one or more predetermined rules to generate a job schedule concerning the project request.

44. The computer program product as recited in claim 39, further comprising providing reminders concerning the project request.

45. The computer program product as recited in claim 39, further comprising providing status updates concerning the project request.

46. The computer program product as recited in claim 39, further comprising receiving, from the client portal, input from the client indicating the product selected by the client.

47. A computer program product for implementing a method for requesting and obtaining a product in a computer network that includes a management platform accessible by way of a client portal and a contractor portal, the computer program product comprising:
a computer readable medium carrying computer executable instructions for performing the method, wherein the method comprises:
receiving, at the client portal, input from a client;
generating, at the client portal, a project request corresponding to the input received from the client;
transmitting the project request to the management platform; and
receiving, at the client portal, a product corresponding to the project request, the product having been generated by at least one contractor of a preselected group of contractors authorized to interact with the client by way of the management platform.

48. The computer program product as recited in claim 47, wherein the project request comprises one of: a creative brief; and, a revision brief.

49. The computer program product as recited in claim 47, further comprising receiving payment information from a client.

50. The computer program product as recited in claim 49, further comprising transmitting the client payment information to the management platform.

51. The computer program product as recited in claim 47, further comprising receiving a status update concerning the project request.

52. The computer program product as recited in claim 47, further comprising receiving a project schedule concerning the project request.

53. The computer program product as recited in claim 47, further comprising receiving a confirmation email concerning the project request.

54. The computer program product as recited in claim 47, further comprising receiving a notification that the product is available for review by the client.

55. A computer program product for implementing a method for managing the performance of work in a computer network that includes a management platform accessible by way of a client portal and a contractor portal, the computer program product comprising:
a computer readable medium carrying computer executable instructions for performing the method, wherein the method comprises:
receiving, at the management platform, a project request from the client portal;
transmitting the project request to the contractor portal for presentation to a preselected group of contractors;
receiving, at the management platform, a project acceptance corresponding to the project request, the project acceptance having been transmitted from the contractor portal;
receiving, at the management platform, a product corresponding to the project acceptance; and
transmitting the product to the client portal.

56. The computer program product as recited in claim 55, further comprising receiving payment information from a client.

57. The computer program product as recited in claim 55, further comprising remitting payment to a contractor.

58. The computer program product as recited in claim 55, further comprising using one or more predetermined rules to generate a job schedule concerning the project request.

59. The computer program product as recited in claim 55, further comprising providing to a contractor a reminder concerning the project request.

60. The computer program product as recited in claim 55, further comprising providing a status update concerning the project request.

61. A method for implementing a performance rating system to facilitate evaluation of the performance of a contractor with respect to one or more clients, the method being implemented in connection with a computer network that includes a management platform accessible by way of a client portal and a contractor portal, and the method comprising:
establishing performance criteria for a contractor concerning products or services requested by a client by way of the client portal;
assigning an initial rating of a predetermined number of points to a contractor;
determining whether the contractor has met the performance criteria;
deducting a predetermined number of points from the initial rating of the contractor if the contractor fails to meet the performance criteria, and then recalculating the contractor rating; and
adding a predetermined number of points to the initial rating of the contractor if the contractor meets the performance criteria, and then recalculating the contractor rating.

62. A method for implementing a peer review system to facilitate evaluation of materials prepared by a contractor for one or more clients, the method being implemented in connection with a computer network that includes a management platform accessible by way of a client portal and a contractor portal, and the method comprising:
assigning an initial rating of a predetermined number of points to the contractor;
presenting, at the contractor portal, the materials prepared by the contractor;
receiving, at the management platform, input from one or more peers concerning the materials prepared by the contractor, the input being transmitted to the management platform by way of the contractor portal;
correlating the input received from the peers with a point value; and
recalculating the rating of the contractor, using the point value.
